(19) United States
(12) Patent Application Publication
(10) Pub. No.: US 2026/0071031 A1
(43) Pub. Date: Mar. 12, 2026

(54) COMPOSTABLE CORE-SHELL PARTICLES FOR IMPACT MODIFICATION OF RIGID PLASTICS

(71) Applicant: IOWA STATE UNIVERSITY RESEARCH FOUNDATION, INC., Ames, IA (US)

(72) Inventors: Eric W. COCHRAN, Ames, IA (US); Michael J. FORRESTER, Ames, IA (US); Baker W. KUEHL, Ankeny, IA (US); Vivek GARG, Ames, IA (US)

(21) Appl. No.: 19/323,048

(22) Filed: Sep. 9, 2025

Related U.S. Application Data
(60) Provisional application No. 63/692,314, filed on Sep. 9, 2024.

(51) Int. Cl. C08J 3/12; C08J 3/24; C08L 63/00; C08L 67/02; C08L 67/04; C08L 95/00; C09D 7/65; C09D 163/00; C09D 167/04; C09J 11/08; C09J 163/00; C09J 167/04

(52) U.S. Cl. CPC C08J 3/126; C08J 3/24; C08L 63/00; C08L 67/02; C08L 67/04; C08L 95/00; C09D 7/65; C09D 163/00; C09D 167/04; C09J 11/08; C09J 163/00; C09J 167/04; C08J 2333/10; C08J 2333/14; C08J 2435/02; C08L 2203/30; C08L 2207/53; C08L 2312/00

(57) ABSTRACT

The present disclosure is directed to a core-shell particle comprising a polymeric core comprising a biodegradable (meth)acrylate polymer, and a first shell surrounding said core. The present disclosure is also directed to a to a method of making the plurality of core-shell particles.

This application claims the benefit of U.S. Provisional Patent Application Ser. No. 63/692,314, filed Sep. 9, 2024, which is hereby incorporated by reference in its entirety.

### FIELD

The present application relates to compostable core-shell particles for impact modification of rigid plastics.

### BACKGROUND

Polymer colloids have increased in popularity since World War II as the desire for a natural rubber latex was sought out (Badía et al., “High Biobased Content Latexes for Development of Sustainable Pressure Sensitive Adhesives,” Ind. Eng. Chem. Res. 57(43):14509-14516 (2018)). Natural rubber latexes consist of a dispersion of polyisoprene particles stabilized by surfactants. Originally, styrene-butadiene rubber (SBR) latexes were the focus; however, emulsion polymerization was recognized for its versatility and has led to a growth in production of a wide range of polymers. Emulsion polymerization is a well-known method for creating high molecular weight polymers due to the elimination of mass and heat transfer allowing for applications suitable for various industries (Lovell and Schork, “Fundamentals of Emulsion Polymerization,” Biomacromolecules 21(11):4396-4441 (2020); Gao et al., “Effect of the Crosslinking Agent Content on the Emulsion Polymerization Process and Adhesive Properties of Poly(N-Butyl Acrylate-Co-Methacrylic Acid),” Journal of Adhesion Science and Technology 33(18):2031-2046 (2019)). This process involves only monomer droplets dispersed in an aqueous phase, which can result in well-defined morphologies and particle size dispersities. Emulsion polymerization is commonly used to develop polymer latexes to produce films, paints, and coatings. Furthermore, this technique can synthesize highly tailored core-shell polymers, which can be generated using seeded semi-batch free radical emulsion polymerizations or a reversible addition-fragmentation chain transfer (RAFT) based approach using highly-engineered surfactants (Zhu et al., “Core-Shell Particles of Poly(Methyl Methacrylate)-Block-Poly(n-Butyl Acrylate) Synthesized via Reversible Addition-Fragmentation Chain-Transfer Emulsion Polymerization and the Polymer's Application in Toughening Polycarbonate,” J. Appl. Polym. Sci. 133:42833 (2016); Fu et al., “Preparation of a Functionalized Core-Shell Structured Polymer by Seeded Emulsion Polymerization and Investigation on Toughening Poly(Butylene Terephthalate),” RSC Advances 4(3):1067-1073 (2014); Chaduc et al., “Batch Emulsion Polymerization Mediated by Poly(Methacrylic Acid) MacroRAFT Agents: One-Pot Synthesis of Self-Stabilized Particles,” Macromolecules 45(15):5881-5893 (2012); Zheng et al., “Biodegradable Core Shell Materials via RAFT and ROP: Characterization and Comparison of Hyperbranched and Microgel Particles,” Macromolecules 44(6):1347-1354 (2011); Plessis et al., “Seeded Semibatch Emulsion Polymerization of N-Butyl Acrylate. Kinetics and Structural Properties,” Macromolecules 33(14):5041-5047 (2000); Plessis et al., “Seeded Semibatch Emulsion Polymerization of Butyl Acrylate: Effect of the Chain-Transfer Agent on the Kinetics and Structural Properties,” J. Polym. Sci. A Polym. Chem. 39(7):1106-1119 (2001)). During free radical emulsion polymerization, RAFT-based polymeric surfactants act as seed stages, allowing existing particles to swell with new monomers (Zhu et al., “Comparison of RAFT Ab Initio Emulsion Polymerization of Methyl Methacrylate and Styrene Mediated by Oligo (Methacrylic Acid-b-Methyl Methacrylate) Trithiocarbonate Surfactant,” Macromolecular Reaction Engineering, 9:503-511 (2015)). Core-shell particles (CSPs), used interchangeably with “core-shell polymers” herein, are used in niche applications requiring high-end performance, such as drug delivery, petroleum refining, hydrophobic coatings, and impact-modified plastics.

High-impact strength plastics typically comprise a brittle matrix with small, dispersed rubber particles, allowing for energy dissipation through viscous dissipation (heat). However, enthalpic interactions must be combated for rubber-modified polymer blends to prevent aggregation (Li et al., “Toughening Glassy Poly(Lactide) with Block Copolymer Micelles,” ACS Macro Lett. 5(3)359-364 (2016); Zhao et al., “Preparation of PBAS Core-Shell Structured Polymer by Seeded Emulsion Polymerization and Investigation in AS Resin Toughness,” J. Appl. Polym. Sci. 125(5):3419-3428 (2012)). Brittle thermoplastic matrices, such as poly(lactide) (PLA), have poor impact strength and elongation, dramatically hindering their use as a single-use plastic. Impact modifiers, like core-shell polymers, are often blended to impart crack resistance and flexibility (Sun and He, “Biodegradable “Core-Shell” Rubber Nanoparticles and Their Toughening of Poly(Lactides),” Macromolecules 46(24):9625-9633 (2013)). Crack resistance is improved via similar mechanisms to how high-impact strength polystyrene (HIPS) eliminates its brittleness (Zhang et al., “Deformation and Toughening Mechanism for High Impact Polystyrene (HIPS) by Pressure-Induced-Flow Processing,” RSC Advances 3(19):6879-6887 (2013)). Polybutadiene (PB), dispersed as small rubber pockets in polystyrene (PS), can undergo cavitation, promoting shear yielding of the matrix, leading to the dispersion of mechanical stresses across a larger matrix volume. CSPs contain a rubbery core with a rigid glassy or semicrystalline shell that is either miscible or graftable to the plastic matrix (Aguiar et al., “Core Shell Polymers with Improved Mechanical Properties Prepared by Microemulsion Polymerization,” Macromolecules 32(20):6767-6771 (1999)). The core provides the energy dissipation mechanisms similar to PB in HIPS. The shell phase interacts with the matrix by physical or chemical coupling to ensure proper rubber dispersion in the polymer matrix. Commercially, core-shell polymers primarily have lightly crosslinked cores of poly(butadiene-stat-styrene) or poly(butyl acrylate). These two rubbers have a low glass transition temperature (Tg) that can efficiently dissipate mechanical energy. The shell comprises poly(methyl methacrylate) (PMMA) as it is highly miscible with many plastic matrices utilized commercially. However, an issue with highly-toughened thermoplastic is compostability and the potential to release microplastics into the environment. Moreover, all the commercially available CSPs are derived from petroleum.

Polymer companies have sought to reduce carbon emissions to create a more sustainable future, leading to the popularity of molecules such as fatty acids and cyclic alcohol-derived monomers, which can be modified with vinyl groups and polymerized further. Due to the hydrophobic nature of the monomers, miniemulsion polymerization is necessary to create the polymer latex requiring large amounts of mechanical energy to prevent complete coagulation (Demchuk et al., “Biobased Latexes from Natural Oil Derivatives,” Industrial Crops and Products 162:113237 (2021); Bunker et al., “Miniemulsion Polymerization of Acrylated Methyl Oleate for Pressure Sensitive Adhesives,” Ind. Eng. Chem. Res. 57:14509-14516 (2018); Medeiros, “Bio-Based Copolymers Obtained through Miniemulsion Copolymerization of Methyl Esters of Acrylated Fatty Acids and Styrene,” J. Polym. Sci. Part A: Polym. Chem. 55(8):1422-1432 (2017)). Solketal acrylate is a radically polymerizable monomer, compatible with oil-in-water emulsion polymerization, that has not yet been thoroughly examined for its potential as a biobased and compostable rubber. It is derived from glycerol, a byproduct of biodiesel production, and acetone through acid-catalyzed transesterification. Solketal can be cleaved under acidic conditions, forming glycerol units, ultimately causing polymer degradation (Mckenzie et al., “Core (Polystyrene)-Shell [Poly(Glycerol Monomethacrylate)] Particles,” ACS Appl. Mater. Interfaces. 9(8):7577-7590 (2017); Jesson et al., “Synthesis of High Molecular Weight Poly(Glycerol Monomethacrylate) via RAFT Emulsion Polymerization of Isopropylideneglycerol Methacrylate,” Macromolecules 51(9):3221-3232 (2018); Goyal et al., “Glycerol Ketals as Building Blocks for a New Class of Biobased (Meth)Acrylate Polymers,” ACS Sustainable Chem. Eng. 9(31):10620-10629 (2021)).

The present disclosure is directed to overcoming these and other deficiencies in the art.

### SUMMARY

One aspect of the present disclosure relates to a core-shell particle. This core-shell particle comprises a polymeric core comprising a biodegradable (meth)acrylate polymer and a first shell surrounding the core.

Another aspect of the present disclosure relates to a composition comprising a plurality of core-shell particles as described herein.

Another aspect of the present disclosure relates to an elastomeric composition that includes a composition comprising a plurality of core-shell particles as described herein.

Another aspect of the present disclosure relates to an elastomeric composition that includes a composition comprising a plurality of core-shell particles as described herein, wherein the composition is vulcanized, cross-linked, compatibilized, and/or compounded with one or more other elastomers, additives, modifiers, and/or fillers.

Another aspect of the present disclosure relates to a toughened engineering thermoplastic composition. This composition includes a composition comprising a plurality of core-shell particles as described herein.

Another aspect of the present disclosure relates to an adhesive composition. This adhesive composition comprises a plurality of core-shell particles as described herein and a tackifier and/or plasticizer blended with the thermoplastic polymeric mixture.

Another aspect of the present disclosure relates to a method of making a plurality of core-shell particles. This method includes providing an emulsion that comprises a collection of droplets dispersed in an aqueous medium, wherein the droplets comprise a plurality of core polymer particles, a non-ionic surfactant that is substantially free from alkylphenols and their ethoxylates (APEs), and a rigid monomer. This method further includes polymerizing the emulsion.

Another aspect of the present disclosure relates to an article of manufacture comprising a plurality of core-shell particles as described herein.

Another aspect of the present disclosure relates to an asphalt product comprising an asphalt binder and the core-shell particles as described herein.

Another aspect of the present disclosure relates to a roofing shingle comprising the asphalt product as described herein.

Another aspect of the present disclosure relates to a coating composition comprising the core-shell particles as described herein.

Solketal (meth)acrylate polymers were synthesized using emulsion polymerization to generate core-shell particles for drug delivery. However, solketal acrylate has not been used as a rubbery core for engineering thermoplastic toughening. The study promotes solketal acrylate as a potential poly(n-butyl acrylate) substitute. Three-layer core-shell particles (CSPs) with a slightly crosslinked rubbery core, a rigid shell phase, and a functional shell were synthesized. The primary focus was on preparing these acrylic CSPs using seeded semi-batch emulsion polymerization and evaluating the performance of these reactive core-shell modifiers in PLA. FIG. 1 shows a process for synthesizing solketal acrylate monomer, followed by the synthesis of the core-shell polymer, and finally, the incorporation of a biodegradable core-shell polymer into a PLA matrix.

Herein is disclosed a biodegradable polymer that shows promise as a replacement for soft acrylics used as rubbers for toughening engineering thermoplastics. By using glycerol-based monomers, a virtually untapped resource in terms of commercial volume and overall cost, a series of core-shell polymers was synthesized via seeded semi-batch emulsion polymerization. While core-shell polymers have been extensively studied, these have been petroleum-based and non-compostable. This study illustrates that solketal acrylate can be used as the basis for bioderived and biodegradable rubber that improves the ductility and impact strength of brittle engineering thermoplastics like PLA, poly(butylene terephthalate) (PBT), polymethylmethacrylate (PMMA), and others. Furthermore, a complete study of these impact-modified PLA composites' mechanical performance and morphology is presented. The significance of these core-shell polymers is the fact that they are bioderived, biodegradable, and are polymerized in water, indicating an easily adaptable and scalable process with minimal VOCs.

### BRIEF DESCRIPTION OF THE DRAWINGS

FIG. 1 shows a process for synthesizing solketal acrylate monomer, the synthesis of the core-shell polymer, and finally, the incorporation of a biodegradable core-shell polymer into a polylactide (PLA) matrix.

FIG. 2 shows a representative Dynamic Light Scattering (DLS) particle size analysis of a seeded semi-batch emulsion polymerized core-shell polymer.

FIG. 3 shows DSC thermograms comparing the normalized heat flow of solketal acrylate synthesized via batch emulsion polymerization (Core Batch) and semi-batch emulsion polymerization (Core Semi-Batch). The thermograms demonstrate the distinct thermal behavior and glass transition temperatures (Tg) of the two polymerization methods.

FIG. 4 is a schematic representation of polymer cores: petroleum-based butyl acrylate core (top) and biodegradable solketal acrylate-derived core (bottom). The illustrations depict the initial polymerization stage (left) and the final core structure (right). Stars indicate ester-based crosslinks, and clusters indicate sites of oxidative metabolic cleavage.

FIG. 5 shows representative Differential Scanning calorimetry (DSC) thermograms of the varying core-shell polymers at different loadings of solketal acrylate.

FIGS. 6A-6B show a Transmission Electron Microscopy (TEM) micrograph (FIG. 6A) and a Scanning Electron Microscopy (SEM) micrograph (FIG. 6B) of the core-shell particles.

FIGS. 7A-7F show SEM and TEM micrographs of the PLA/CSP composites. FIGS. 7A-7C show SEM micrographs at Low (60×) (FIG. 7A), Medium (1500×) (FIG. 7B), and High (5000×) (FIG. 7C) magnifications of CSP-modified PLA. The micrographs were collected from the fracture surfaces of a Notched Izod test specimens, as specified by ASTM D256, post-deformation. FIGS. 7D-7F show corresponding TEM micrographs that reveal the CSP dispersion throughout the PLA matrix. The inset in FIG. 7A is a micrograph of the fracture surface from a neat (CSP-free) PLA Notched Izod specimen.

FIG. 8 shows a bar graph that compares the impact strength data of various core-shell polymer modified polymer blends. The image on the right shows strain-induced whitening of a tensile bar specimen composed of a core-shell polymer modified polylactide.

FIGS. 9A-9B show diagrams illustrating the role of surfactant critical micelle concentration on the effective surface coverage of compostable core-shell particles (CCSPs). The diagram on the left shows the core seed latex with a surfactant featuring CMC>0.1 wt %. Here, nearly all surfactant localizes at the core particle-monomer interface. As shell monomer is introduced, the monomer partitions to and polymerizes at the core particle surface. Conversely, the diagram on the right shows a core seed latex formed with surfactants featuring CMC<0.1 wt %. Here, excess surfactant readily forms new micelles. Small surfactant dosing deviations drive the shell monomer into new micelles, reducing interfacial wetting and yielding incomplete poorly formed core-shell particles.

FIGS. 10A-10D show CCSPs spray dried using surfactants with CMC<0.1 wt % yielded agglomerated particles attributed to the poor shell coverage. Conversely, CCSPs spray dried using surfactants with CMC>0.1 wt % yielded a finely dispersed powder as evidenced by the SEM.

FIG. 11 shows morphological characterization of core-shell polymer dispersed in PLA matrix using Small angle X-ray Scattering. The scattering profile conforms to the structure factor of monodisperse spheres.

FIG. 12 shows impact strength in compostable core-shell particle (CCSP) modified polylactides as a function of EP-255 loading.

FIGS. 13A-13C show tensile strength, elongation at break, and ultimate toughness of compostable core-shell particle (CCSP) modified polylactides as a function of EP-255 loading.

FIGS. 14A-14D show CCSPs synthesized with surfactants with CMC>0.1 wt % as well as a pH between 7.0-8.5 yielded epoxy functionalized CCSPs that when compounded into PBT provides stress whitening and cavitation of rubbery particles yielded a rough impact surface indicating plastic deformation.

FIGS. 15A-15F show morphological characterization of core-shell polymer dispersed in PBT matrix using atomic force microscopy. The elongated particles show cavitation of the rubber particles and shear alignment post-deformation.

FIGS. 16A-16C show an acidic hydrolysis study of solketal-acrylate copolymers that illustrate the breakdown of the acetal linkage.

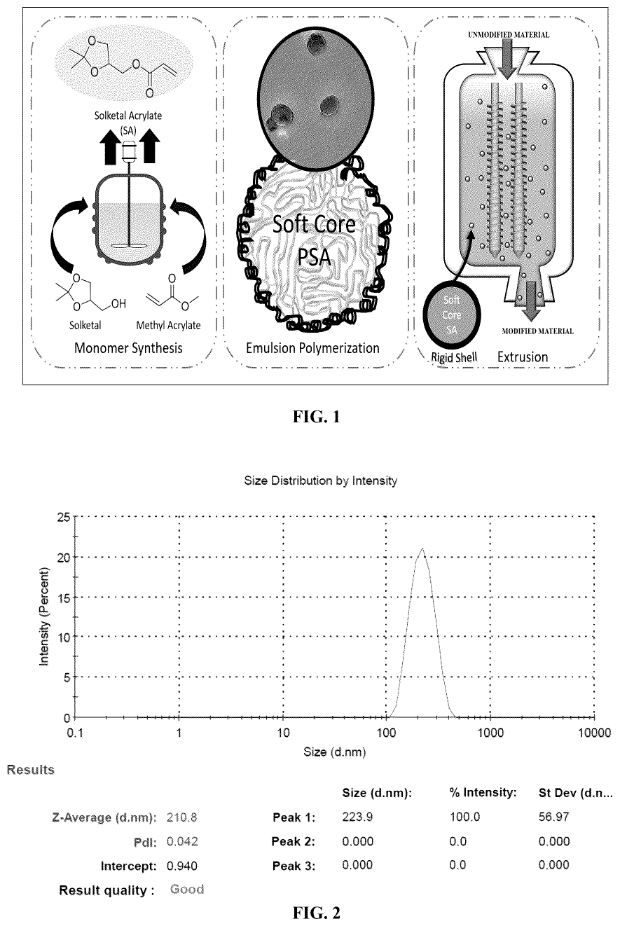

### DETAILED DESCRIPTION

One aspect of the present disclosure relates to a core-shell particle. This core-shell particle comprises a polymeric core comprising a biodegradable (meth)acrylate polymer and a first shell surrounding the core.

As used above and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

In this specification and the appended claims, the singular forms “a,” “an,” and “the” include plural references unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements, or method steps.

The terms “comprising,” “comprises,” and “comprised of” also encompass the term “consisting of.” The transitional term “comprising,” which is synonymous with “including,” “containing,” or “characterized by,” is inclusive or open-ended and does not exclude additional, un-recited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed subject matter. In some embodiments or claims where the term comprising is used as the transition phrase, such embodiments can also be envisioned with replacement of the term “comprising” with the terms “consisting of” or “consisting essentially of.”

Terms of degree such as “substantially,” “about,” and “approximately” and the symbol “˜” as used herein mean a reasonable amount of deviation of the modified term such that the end result is not significantly changed. These terms of degree should be construed as including a deviation of at least ±0.1% (and up to ±1%, ±5%, or ±10%) of the modified term if this deviation would not negate the meaning of the word it modifies. Unless otherwise clear from context, all numerical values provided herein are modified by the term about. All numerical values provided herein that are modified by terms of degree set forth in this paragraph (e.g., “substantially,” “about,” “approximately,” and “˜”) are also explicitly disclosed without the term of degree. For example, “about 1%” is also explicitly disclosed as “1%”.

The term “and/or” as used herein means that the listed items are present or used individually or in combination. In effect, this term means that “at least one of” or “one or more” of the listed items is used or present.

The recitation of numerical ranges by endpoints includes all numbers and fractions subsumed within the respective ranges, as well as the recited endpoints. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

As used herein, the term “biodegradability” refers to the ability of a material to break down into simpler substances through the action of biological organisms, typically microorganisms like bacteria and fungi. Biodegradability can occur via various pathways, such as oxidative or hydrolytic, depending on the material's chemical structure. For example, hydrolytic biodegradation involves the cleavage of bonds by water, including ester and ketal bonds. Oxidative biodegradation occurs through reactions with oxygen and carbon. The measurement of biodegradability often includes methods like respirometry, where the consumption of oxygen (or the release of CO₂) is monitored to gauge microbial activity and quantify the extent of degradation. Industry-standard tests for biodegradability include OECD 301F, which measures the biological oxygen demand (BOD) or carbon dioxide evolution under controlled conditions, and ASTM D6400, which assesses compostability under industrial composting conditions. Compostability is often considered a subset of biodegradability and refers to the ability of a material to break down in a composting environment, forming water, CO₂, and biomass without leaving toxic residues. Relevant compostability standards include ASTM D6400 and EN 13432, which specify that a material must disintegrate within 12 weeks and fully biodegrade within six months under industrial composting conditions. The term “biodegradable” in this application means materials that degrade into environmentally benign products within a reasonable timeframe under the action of biological activity.

In some embodiments, the core-shell particle further comprises a second shell surrounding the first shell.

In some embodiments, the core is biobased.

In some embodiments, the core-shell particle is biodegradable. In some embodiments, the core-shell particle is biobased.

As used herein, the term “biobased” refers to material that comes from plants or animals. The determination of a material's biobased content is achieved via radiocarbon dating to identify the amount of carbon-14, which is easily differentiated from other materials, such as fossil fuels that do not contain any carbon-14. ASTM D6866 is the standard test method developed by ASTM International (formerly the American Society for Testing and Materials) to determine the biobased carbon/biogenic carbon content of solid, liquid, and gaseous samples using radiocarbon analysis. It is important to note that “biobased” refers specifically to the source of the carbon in the material and does not necessarily imply that the material is biodegradable, compostable, or environmentally benign. Biobased materials can exhibit a wide range of environmental impacts and performance characteristics depending on their chemical composition and processing, and as such, their classification as “biobased” pertains strictly to the biological origin of the material's carbon content.

As used herein, the terms “core-shell polymer” and “core-shell particle” are used interchangeably. A “core-shell polymer” refers to a composite particle, typically with an approximately spherical geometry. These particles comprise a “core” made of one type of polymeric material at the center, surrounded by at least one “shell” of a different polymeric material that encapsulates the core. Core-shell polymers can also feature multiple concentric shells of varying polymeric compositions, forming more complex multilayer structures.

In some embodiments of the core-shell particle, the biodegradable (meth)acrylate polymer comprises a glycerol-based monomer. In some embodiments, the biodegradable (meth)acrylate polymer comprises solketal (meth)acrylate, butyl (meth)acrylate, isobornyl (meth)acrylate, octyl (meth)acrylate, lauryl (meth)acrylate, cetyl (meth)acrylate, beheynl (meth)acrylate, glycerol-cyclopentanone ketal (meth)acrylate, acrylated epoxidized methyl (meth)soyate, acrylated epoxidized ethyl hexyl (meth)soyate, glycerol-butanone ketal (meth)acrylate, acrylated epoxidized methyl (meth)soyate, acrylated acetylated epoxidized solketal, tetrahydrofuranyl (meth)acrylate, or tetrahydrofurfuryl glycerol ketal (meth)acrylate.

In some embodiments of the core-shell particle, the core further comprises a crosslinker. In some embodiments, the crosslinker is present in 1-5 mol % of the biodegradable (meth)acrylate polymer.

Suitable crosslinkers that can be used include ethylene glycol diacrylate, ethylene glycol dimethacrylate, 1,3 butylene glycol diacrylate, 1,4-butyleneglycol diacrylate propylene glycol diacrylate, triethyleneglycoldimethylacrylate, 1,3-glycerol dimethacrylate, 1,1,1-trimethylol propane dimethacrylate, 1,1,1-trimethylol ethanediacrylate, pentaerythritol trimethacrylate, 1.2.6-hexane triacrylate, sorbitol pentamethacrylate; methylene bis-acrylamide, methylene bis-methacrylamide, divinyl benzene, vinylmethacrylate, vinyl crotonate, vinyl acrylate, vinyl acetylene, trivinyl benzene, triallyl cyanurate, divinyl acetylene, divinylethane, divinyl sulfide, divinyl ether, divinyl sulfone, diallyl cyanamide, ethylene glycol divinyl ether, diallyl phthalate, divinyl dimethyl silane, glycerol trivinylether, divinyl adipate; dicyclopentenyl (meth)acrylate, dicyclopentenyloxy (meth)acrylate, allyl methacrylate, allyl acrylate, diallyl maleate, diallyl fumarate, and diallyl itaconate.

In some embodiments of the core-shell particle, the average molecular weight between the crosslinks is below about 3000 Da. In some embodiments, the average molecular weight between the crosslinks is below about 2400 Da. For example, in some embodiments, the average molecular weight between the crosslinks is from about 1000 Da to about 3000 Da, from about 1500 Da to about 3000 Da, from about 2000 Da to about 3000 Da, from about 2500 Da to about 3000 Da, from about 1000 Da to about 2500 Da, from about 1500 Da to about 2500 Da, from about 2000 Da to about 2500 Da, from about 1000 Da to about 2400 Da, from about 1200 Da to about 2400 Da, from about 1500 Da to about 2400 Da, from about 2000 Da to about 2400 Da, from about 1000 Da to about 2000 Da, from about 1200 Da to about 2000 Da, from about 1500 Da to about 2000 Da, or from about 1000 Da to about 1500 Da.

In some embodiments of the core-shell particle, the glass transition temperature of the polymeric core is below 0° C.

The term “glass transition temperature” or “Tg” refers to the temperature at which a polymeric material transitions from a glassy state (e.g., brittleness, stiffness, and rigidity) to a rubbery state (e.g., flexible and elastomeric). The Tg can be determined, for example, using techniques such as Differential Scanning calorimetry (DSC) or Dynamic Mechanical Analysis (DMA).

In some embodiments, the glass transition temperature of the polymeric core is below −10° C. In some embodiments, the glass transition temperature of the polymeric core is between about −80° C. and about −40° C. In some embodiments, the glass transition temperature is between about −80° C. and about −50° C., between about −80° C. and about −60° C., between about −80° C. and about −70° C., between about −70° C. and about −40° C., between about −70° C. and about −50° C., between about −70° C. and about −60° C., between about −60° C. and about −40° C., or between about −60° C. and about −50° C.

In some embodiments, the polymeric core is polysolketal acrylate and the glass transition temperature of the polymeric core is below about −6° C., below about −7° C., below about −8° C., below about −9° C., or below about −10° C.

In some embodiments of the core-shell particle, the first shell comprises a rigid polymer.

As used herein, “rigid polymer” is defined as a polymer that resists deformation and maintains its shape under stress, including both glassy polymers below their glass transition temperature and semicrystalline polyesters below their melting temperature, which exhibit enhanced stiffness due to their crystalline regions (Young's modulus >100 Mpa, preferably >1 GPa).

In some embodiments, the rigid polymer has a Young's modulus above 100 MPa. In other embodiments, the rigid polymer has a Young's modulus from about 500 MPa to about 500 GPa.

Suitable rigid polymers include those derived from methyl (meth)acrylate, glycidyl (meth)acrylate, cyclohexyl (meth)acrylate, glycerol (meth)acrylate, (meth)acrylated diglycidyl ether, isobornyl (meth)acrylate, solketal (meth)acrylate, butyl (meth)acrylate, isobornyl (meth)acrylate, octyl (meth)acrylate, lauryl (meth)acrylate, cetyl (meth)acrylate, beheynl (meth)acrylate, glycerol-cyclopentanone ketal (meth)acrylate, acrylated epoxidized methyl (meth)soyate, acrylated epoxidized ethyl hexyl (meth)soyate, glycerol-butanone ketal (meth)acrylate, acrylated epoxidized methyl (meth)soyate, acrylated acetylated epoxidized solketal, tetrahydrofuranyl (meth)acrylate, styrene, acrylonitrile, vinyl pyridine, hydroxyethyl (meth)acrylate, (meth)acrylic acid, or tetrahydrofurfuryl glycerol ketal (meth)acrylate.

In some embodiments of the core-shell particle, the first shell comprises a homopolymer or a copolymer.

The term “copolymer” refers to a polymer derived from more than one species of monomer.

In some embodiments, the first shell further comprises a crosslinker.

In some embodiments of the core-shell particle, the second shell comprises a homopolymer or a copolymer.

In some embodiments, the second shell further comprises a crosslinker.

In some embodiments, the second shell comprises a rigid polymer.

Suitable rigid polymers include those derived from methyl (meth)acrylate, glycidyl (meth)acrylate, cyclohexyl (meth)acrylate, glycerol (meth)acrylate, (meth)acrylated diglycidyl ether, isobornyl (meth)acrylate, solketal (meth)acrylate, butyl (meth)acrylate, isobornyl (meth)acrylate, octyl (meth)acrylate, lauryl (meth)acrylate, cetyl (meth)acrylate, beheynl (meth)acrylate, glycerol-cyclopentanone ketal (meth)acrylate, acrylated epoxidized methyl (meth)soyate, acrylated epoxidized ethyl hexyl (meth)soyate, glycerol-butanone ketal (meth)acrylate, acrylated epoxidized methyl (meth)soyate, acrylated acetylated epoxidized solketal, tetrahydrofuranyl (meth)acrylate, styrene, acrylonitrile, vinyl pyridine, hydroxyethyl (meth)acrylate, (meth)acrylic acid, or tetrahydrofurfuryl glycerol ketal (meth)acrylate.

In some embodiments, the second shell comprises polymers derived from glycidyl methacrylate.

In some embodiments of the core-shell particle, the particle has a diameter of less than 500 nm. In some embodiments, the particle has a diameter of about 100 nm to about 500 nm. For example, in some embodiments, the particle has a diameter of about 150 nm to about 500 nm, about 200 nm to about 500 nm, about 250 nm to about 500 nm, about 300 nm to about 500 nm, about 350 nm to about 500 nm, about 400 nm to about 500 nm, about 450 nm to about 500 nm, about 150 nm to about 450 nm, about 200 nm to about 450 nm, about 250 nm to about 450 nm, about 300 nm to about 450 nm, about 350 nm to about 450 nm, about 400 nm to about 450 nm, about 150 nm to about 400 nm, about 200 nm to about 400 nm, about 250 nm to about 400 nm, about 300 nm to about 400 nm, about 350 nm to about 400 nm, about 150 nm to about 350 nm, about 200 nm to about 350 nm, about 250 nm to about 350 nm, about 300 nm to about 350 nm, about 150 nm to about 300 nm, about 200 nm to about 300 nm, about 250 nm to about 300 nm, about 150 nm to about 250 nm, about 200 nm to about 250 nm, or about 150 nm to about 200 nm.

Another aspect of the present disclosure relates to a composition comprising a plurality of core-shell particles as described herein.

In some embodiments, the composition further comprises a polymer.

In some embodiments, the polymer is a thermoplastic polymer, epoxy polymer, polyurethane, or a thermoset polymer.

As used herein, the term “thermoplastic” refers to polymeric material that flows when heated and then returns to its original state when cooled to room temperature. However, under some conditions (e.g., applications where solvent resistance or higher temperature performance is desired), the thermoplastic polymers can be covalently crosslinked. Upon crosslinking, the materials lose their thermoplastic characteristics and become thermoset materials.

As used herein, the term “thermoset” refers to polymeric materials that become infusible and insoluble upon heating and that do not return to their original chemical state upon cooling. Thermoset materials tend to be insoluble and resistant to flow.

Suitable thermoplastic polymers that can be used include poly(styrene), poly(methylmethacrylate), Nylon 6, Nylon 4, Nylon 6,6, poly(lactide), poly butylene succinate, poly hydroxyalkanoates, polyethylene terephthalate, polybutylene terephthalate, polypropylene furanoate, polyethylene furanoate, and combinations thereof. In some embodiments, the thermoplastic polymer is poly(lactide). In some embodiments, the thermoplastic polymer is polybutylene terephthalate.

As used herein, the term “polylactic acid” or “polylactide” (PLA) includes poly(D-lactide), poly(L-lactide), poly(DL-lactide), and combinations thereof. PLA, in general has a formula of:

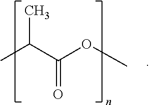

PLAs are polymers produced by the ring-opening polymerization of lactide or the polycondensation of lactic acid, which is typically derived from a starch from corn or potatoes.

In some embodiments, the epoxy polymer is an epoxy resin. Suitable epoxy resins include D.E.R®. 331, D.E.R.332, D.E.R. 383, D.E.R. 334, D.E.R. 580, D.E.N. 431, 30 D.E.N. 438, D.E.R. 736, or D.E.R. 732 epoxy resins available from The Dow Chemical Company, or Syna 21 cycloaliphatic epoxy resin from Synasia. An exemplary epoxy resin component that may be used may be a mixture of a liquid epoxy resin, such as D.E.R. 383, an epoxy; Novolac DEN 438, a cycloaliphatic epoxide; Syna 21; and a divinylarene dioxide, divinylbenzene dioxide (DVBDO) and mixtures thereof.

Another aspect of the present disclosure relates to an elastomeric composition that includes a composition comprising a plurality of core-shell particles as described herein.

The elastomeric composition may be vulcanized, cross-linked, compatibilized, and/or compounded with one or more other elastomer, additive, modifier and/or filler.

The composition of the present disclosure may be used in a toughened engineering thermoplastic composition.

As used herein, the term “engineering thermoplastics” refers to a group of polymers that possess a balance of properties comprising strength, stiffness, impact resistance, and long-term dimensional stability that make them useful as structural materials. The engineering thermoplastics of the present disclosure may be formed into a wide variety of articles such as films, pipes, fibers (e.g., dyeable fibers), rods, containers, bags, packaging materials, and adhesives (e.g., hot melt adhesives) for example, by polymer processing techniques known to one of skill in the art, such as forming operations including film, sheet, pipe, and fiber extrusion and co-extrusion as well as blow molding, injection molding, rotary molding, and thermoforming, for example. Films include blown, oriented, or cast films formed by extrusion or co-extrusion or by lamination, useful as shrink film, cling film, stretch film, sealing films, oriented films, snack packaging, heavy-duty bags, grocery sacks, baked and frozen food packaging, medical packaging, industrial liners, and membranes, for example, in food-contact and non-food contact applications. Fibers include slit-films, monofilaments, melt spinning, solution spinning, and melt-blown fiber operations for use in the woven or non-woven form to make sacks, bags, rope, twine, carpet backing, carpet yarns, filters, diaper fabrics, medical garments, and geotextiles, for example. Extruded articles include medical tubing, wire and cable coatings, hot melt adhesives, sheets such as thermoformed sheets (including profiles and plastic corrugated cardboard), geomembranes, and pond liners, for example. Molded articles include single and multilayered constructions in the form of bottles, tanks, large hollow articles, rigid food containers, and toys, for example.

Another aspect of the present disclosure relates to an adhesive composition. This adhesive composition includes a plurality of core-shell particles as described herein, and a tackifier and/or plasticizer blended with the thermoplastic polymeric mixture.

Suitable tackifiers include, but are not limited to, isosorbide-based tackifiers; Piccotac™ 1095 and Piccotac™ 8095 (Eastman Chemical Company, Kingsport, Tennessee); glycerol ester tackifiers, such as Staybelite™ Ester 10-E Ester of Hydrogenated Rosin and Staybelite™ Ester 3-E Ester of Hydrogenated Resin (Eastman Chemical Company, Kingsport, Tennessee); Floral™ AX-E Fully Hydrogenated Rosin (Eastman Chemical Company, Kingsport, Tennessee); phenolic resins; styrenated terpenes; polyterpenes; rosin esters; terpene phenolics; and monomeric resins.

Suitable plasticizers include, but are not limited to, benzoflex 2088 (DEGD); abietic acid; Eastman Triacetin™ and Eastman 168™ (Eastman Chemical Company, Kingsport, Tennessee); non-phthalate plasticizer; polyalkylene esters, such as polyethylene glycol, polytetramethylene glycol, polypropylene glycol, and mixtures thereof; glyceryl monostearate; octyl epoxy soyate, epoxidized soybean oil, epoxy tallate, and epoxidized linseed oil; polyhydroxyalkanoate; glycols, such as thylene glycol, pentamethylene glycol, and hexamethylene glycol; anionic or cationic plasticizers, such as dioctyl sulfosuccinate, alkane sulfonate, and sulfonated fatty acid; phthalate or trimellitate plasticizers; polyethylene glycol di-(2-ethylhexoate); citrate esters; naphthenic oil and dioctyl phthalate; white oil; lauric, sebacic, or citric acids esters; nonfugitive polyoxyethylene aryl ether; copolymer of ethylene and carbon monoxide; photopolymerizable unsaturated liquid plasticizer; and sorbitol.

The adhesive composition can also include a filler selected from the group consisting of ground mica, talc, kaolin clay, calcium carbonate, calcium sulfite, colloidal silica, wollastonite, ballotini, hollow glass microspheres, glass, carbon and graphite fibers, zinc, titanium, zirconium, ground quartz, metallic silicates, and metallic powders.

Another aspect of the present disclosure relates to a method of making a plurality of core-shell particles. This method includes providing an emulsion that comprises a collection of droplets dispersed in an aqueous medium, wherein the droplets comprise a plurality of core polymer particles, a non-ionic surfactant that is substantially free from alkylphenols and their ethoxylates (APEs), and a rigid monomer. This method further includes polymerizing the emulsion.

In some embodiments, the droplets further comprise an ionic surfactant with a critical micelle concentration (CMC) greater than or equal to 0.1 wt % and less than or equal to 1.5 wt %.

In some embodiments, the polymerizing is carried out using seeded emulsion polymerization. In certain embodiments, the polymerizing is carried out using seeded semi-batch polymerization.

In some embodiments, the method further includes i) providing a pre-emulsion, ii) providing a pre-made seed latex, and iii) combining the pre-emulsion with the pre-made seed latex to form the emulsion that comprises a collection of droplets.

In some embodiments, the pre-emulsion can be prepared by combining i) a first solution comprising an ionic surfactant, a nonionic surfactant, an initiator, and one or more polymerizable surfactants with ii) a second solution comprising a biodegradable solketal acrylate, a monomer comprising a methacrylate bond and a low reactivity allyl bond, and a di-functional acrylate monomer.

In some embodiments, the pre-emulsion can be prepared by combining i) a first solution comprising an anionic surfactant, a nonionic surfactant, an initiator, and one or more polymerizable surfactants with ii) a second solution comprising a biodegradable solketal acrylate, a monomer comprising a methacrylate bond and a low reactivity allyl bond, and a di-functional acrylate monomer.

In some embodiments, the ionic surfactant (e.g., anionic or cationic surfactant) has a critical micelle concentration (CMC) in water at 20-25° C. of greater than 0.1 wt %.

In some embodiments, the ionic surfactant (e.g., anionic or cationic surfactant) has a CMC in water at 20-25° C. that is between about 0.10 wt % and about 1.50 wt %, between about 0.10 wt % and about 1.40 wt %, between about 0.10 wt % and about 1.30 wt %, between about 0.10 wt % and about 1.20 wt %, between about 0.10 wt % and about 1.10 wt %, between about 0.10 wt % and about 1.00 wt %, between about 0.10 wt % and about 0.90 wt %, between about 0.10 wt % and about 0.80 wt %, between about 0.10 wt % and about 0.70 wt %, between about 0.10 wt % and about 0.60 wt %, between about 0.10 wt % and about 0.50 wt %, between about 0.20 wt % and about 1.40 wt %, between about 0.30 wt % and about 1.40 wt %, between about 0.40 wt % and about 1.40 wt %, between about 0.50 wt % and about 1.40 wt %, between about 0.60 wt % and about 1.40 wt %, between about 0.70 wt % and about 1.40 wt %, between about 0.80 wt % and about 1.40 wt %, between about 0.90 wt % and about 1.40 wt %, between about 1.00 wt % and about 1.40 wt %, between about 0.90 wt % and about 1.30 wt %, or between about 1.00 wt % and about 1.30 wt %.

In some embodiments, the ionic surfactant (e.g., anionic or cationic surfactant) is selected from the group consisting of sodium dodecyl sulfate (SDS; sodium lauryl sulfate); lithium dodecyl sulfate; sodium cholate; sodium deoxycholate; sodium chenodeoxycholate; sodium taurocholate; sodium N-lauroyl sarcosinate (sarkosyl); dodecyltrimethylammonium bromide; tetradecyltrimethylammonium bromide; 3-[(3-cholamidopropyl)dimethylammonio]-1-propanesulfonate (CHAPS); 3-[(3-cholamidopropyl)dimethylammonio]-2-hydroxy-1-propanesulfonate (CHAPSO); n-decyl-N,N-dimethyl-3-ammonio-1-propanesulfonate, N,N-bis(3-D-gluconamidopropyl) deoxycholamide, N,N-bis(3-D-gluconamidopropyl) cholamide; zwitterionic phosphocholine analogs including n-decylphosphocholine, iso-nonylphosphocholine, iso-undecylphosphocholine, iso-undec-6-enylphosphocholine, undec-10-enylphosphocholine, n-dodecylphosphocholine; N-decanoyl-N-methyl-D-glucamine (MEGA-10); cyclohexyl maltosides including CyMAL-4 and CyMAL-5; alcohol ethoxylates including hexaethylene glycol monodecyl ether (C10E6) and pentaethylene glycol monooctyl ether (C8E5); phosphine oxides including dimethyloctylphosphine oxide and dimethyldecylphosphine oxide; amine oxides including n-decyl-N,N-dimethylamine-N-oxide; and sulfosuccinates selected from sodium dioctyl sulfosuccinate (AEROSOL® OT grades, including OT-75, OT-75 E OPV, GPG, OT-70 PG, OT-70 PG OPV, OT-75 PG, OT-100, OT-B, OT-A (ND), OT-S and OT-SE ULA), sodium dihexyl sulfosuccinate (AEROSOL® MA-80 and MA-80 I), disodium ethoxylated alcohol half-ester of sulfosuccinic acid (AEROSOL® A-102), and sodium diisopropyl naphthalene sulfonate (AEROSOL® OS); and mixtures thereof.

In some embodiments, the ionic surfactant is selected from the group consisting of sodium cholate (CMC≈0.41-0.60 wt %), sodium taurocholate (CMC≈0.57-0.71 wt %), FOS-CHOLINE®-ISO-9 (CMC≈0.99 wt %), FOS-CHOLINE®-ISO-11 (CMC≈0.90 wt %), FOS-CHOLINE®-ISO-11-6U (CMC≈0.87 wt %), FOS-CHOLINE®-10 (CMC≈1.20 wt %), sulfobetaine SB3-10 (CMC≈1.20 wt %), n-octyl-β-D-maltopyranoside (CMC≈0.89 wt %), and sodium diisopropyl naphthalene sulfonate (AEROSOL® OS; CMC≈1.0 wt %).

In some embodiments, the anionic surfactant is an ethoxylated anionic surfactant.

An ethoxylated anionic surfactant is a type of surfactant that combines ethoxylation with anionic properties, providing excellent emulsifying, wetting, and detergent capabilities. It is widely used in various industries, including cleaning, personal care, and agriculture, for its ability to reduce surface tension and improve the mixing and spreading of different substances.

In some embodiments, the anionic surfactant contains 2-3 ethylene oxide units (such as Rhodapex EST-30).

In some embodiments, the anionic surfactant has a critical micelle concentration of greater than 0.1 wt %.

In some embodiments, the non-ionic surfactant is a saccharide non-ionic surfactant. Suitable saccharide non-ionic surfactants that can be used include, without limitation, n-octyl-β-D-glucopyranoside, n-octyl-β-D-galactopyranoside, n-octyl-β-D-maltopyranoside, n-octyl-β-D-thioglucopyranoside, n-octyl-β-D-thiomaltopyranoside, n-nonyl-β-D-glucopyranoside, n-nonyl-β-D-maltopyranoside, n-nonyl-β-D-thiomaltopyranoside, and n-heptyl-β-D-thioglucopyranoside.

In some embodiments, the non-ionic surfactant that is substantially free from alkylphenols and their ethoxylates (APEs) is an alkylphenol-ethoxylate-free (APE-free) surface-active agent.

In some embodiments, the APE-free non-ionic surfactant is selected from iso-nonylphosphocholine, iso-undecylphosphocholine, iso-undec-6-enylphosphocholine, n-decylphosphocholine, n-decyl-N,N-dimethyl-3-ammonio-1-propanesulfonate, n-octyl-β-D-maltopyranoside, polyoxyethylene secondary alcohol ethers containing between 20 and 50 ethylene oxide units, polyoxyethylene linear alcohol ethers containing between 20 and 50 ethylene oxide units, and polyoxyethylene alkylphenyl ether-free surfactants derived from branched fatty alcohols containing between 20 and 50 ethylene oxide units.

In some embodiments, the APE-free non-ionic surfactant is Tergitol™.

In some embodiments, the APE-free non-ionic surfactant is Abex 2535.

In some embodiments, the APE-free non-ionic surfactant is Brij 35 (polyoxyethylene (23) ether).

In some embodiments, the APE-free non-ionic surfactant is Brij 58 (polyoxyethylene (20) cetyl ether).

In some embodiments, the APE-free non-ionic surfactant is Brij 78 (polyoxyethylene (20) stearyl ether).

In some embodiments, the APE-free non-ionic surfactant is Brij 98 (polyoxyethylene (20) oleyl ether).

In some embodiments, the APE-free non-ionic surfactant is Polysorbate 20 (polyoxyethylene (20) sorbitan monolaurate).

In some embodiments, the APE-free non-ionic surfactant is Polysorbate 40 (polyoxyethylene (20) sorbitan monopalmitate).

In some embodiments, the APE-free non-ionic surfactant is Polysorbate 60 (polyoxyethylene (20) sorbitan monostearate).

In some embodiments, the APE-free non-ionic surfactant is Polysorbate 80 (polyoxyethylene (20) sorbitan monooleate).

In some embodiments, the APE-free non-ionic surfactant is a mixture of multiple APE-free non-ionic surfactants.

In some embodiments, the initiator is a water-soluble initiator.

In some embodiments, the initiator is KPS-2 wt %.

Suitable polymerizable surfactants include Sipomer COPS-1 and Sipomer AES-100. Both Sipomer COPS-1 and Sipomer AES-100 are polymerizable surfactants that can help with grit reduction as well as stability.

A biobased solketal acrylate can provide Tg suppression/reduction behavior.

In some embodiments, the monomer comprising a methacrylate bond and a low reactivity allyl bond is allyl methacrylate (ALMA). ALMA contains the allyl carbon-carbon bonds that have low reactivity.

The di-functional acrylate monomer can impart biodegradability to keep the MW between crosslinks below 2400 Da.

In some embodiments, the di-functional acrylate monomer is butanediol diacrylate.

In some embodiments, the second solution further comprises butyl acrylate.

In some embodiments, the method further comprises providing a solution comprising a monomer and a buffer; and providing a monoethylenically unsaturated monomer. The method further comprises combining the monoethylenically unsaturated monomer with the solution to form a mixture; and emulsifying the mixture to form the pre-made seed latex.

In some embodiments, the method further comprises combining a monoethylenically unsaturated monomer with a solution comprising i) a monomer and ii) a buffer to form a mixture. The method further includes emulsifying the mixture to form the pre-made seed latex.

An exemplary buffer that can be used is sodium bicarbonate. In come embodiments, sodium bicarbonate is used to keep the pH above 7 in order to prevent coagulation of the emulsion polymerization with acetal-based monomers.

In some embodiments, the monoethylenically unsaturated monomer is butyl acrylate.

In some embodiments, the solution further comprises a basic anionic surfactant, such as sodium dodecyl sulfate.

In some embodiments, the method involves spray drying the plurality of core-shell particles.

In some embodiments of the method, the plurality of core-shell particles has a monomodal size distribution.

Another aspect of the present disclosure relates to an article of manufacture comprising a plurality of core-shell particles as described herein.

In some embodiments, the article of manufacture further comprises a polymer.

Another aspect of the present disclosure relates to an asphalt product comprising an asphalt binder and a core-shell particle, as described herein.

Suitable asphalt binders include bitumen, bio-asphalt, plant oil binders, animal fat binders, maltenes, unaged asphalt binder, aged asphalt binder from recycled asphalt pavement, vacuum tower distillation bottom binder, aged asphalt binder from recycled asphalt shingles, de-asphalting bottoms, residuum oil supercritical extraction unit bottoms, and mixtures thereof.

In some embodiments, the asphalt product further comprises a rejuvenator. Rejuvenators and softening agents have been successfully implemented to offset the high stiffness and low creep rate of aged, recycled asphalt pavement (RAP) asphalt binder. Use of rejuvenators and/or softening agents has resulted in considerable improvement to low-temperature mix properties of mixtures with high RAP content (Hajj et al., “Influence of Hydrogreen Bioasphalt on Viscoelastic Properties of Reclaimed Asphalt Mixtures,” Transportation Research Record: Journal of the Transportation Research Board 2371:13-22 (2013); Shen et al., “Effects of Rejuvenating Agents on Superpave Mixtures Containing Reclaimed Asphalt Pavement,” Journal of Materials in Civil Engineering 19(5):376-384 (2007); and Zaumanis et al., “Influence of Six Rejuvenators on the Performance Properties of Reclaimed Asphalt Pavement (RAP) Binder and 100% Recycled Asphalt Mixtures,” Construction and Building Materials 71:538-550 (2014), which are hereby incorporated by reference in their entirety).

Rejuvenators and/or softening agents are chemical or bio-derived additives that typically contain a high proportion of maltenes, which serves to replenish the maltene content in the aged bitumen that has been lost as a result of oxidation, leading to increased stiffness (Copeland, A., “Reclaimed Asphalt Pavement in Asphalt Mixtures: State of the Practice,” (2011), which is hereby incorporated by reference in its entirety). Binder aging is characterized by a change of the maltenes fraction into asphaltene through oxidation. The amount of asphaltene is related to the viscosity of asphalt (Firoozifar et al., “The Effect of Asphaltene on Thermal Properties of Bitumen,” Chemical Engineering Research and Design 89:2044-2048 (2011), which is hereby incorporated by reference in its entirety). The addition of maltenes helps rebalance the chemical composition of the aged bitumen, which contains a high percentage of asphaltenes (causing high stiffness and low creep rate). Rejuvenators and softening agents recreate the balance between the asphaltene and maltene by providing more maltenes and/or by allowing better dispersion of the asphaltenes (Elseifi et al., “Laboratory Evaluation of Asphalt Mixtures Containing Sustainable Technologies,” Journal of the Association of Asphalt Paving Technologists 80 (2011), which is hereby incorporated by reference in its entirety). Rejuvenators are added during mixing and are believed to diffuse within the aged bitumen imparting softening characteristics. The rejuvenator initially coats the outside of the RAP aggregates before they gradually seep into the aged bitumen layer until they diffuse through the film thickness (Carpenter et al., “Modifier Influence in the Characterization of Hot-Mix Recycled Material,” Transportation Research Record 777 (1980), which is hereby incorporated by reference in its entirety). In one embodiment, the hot-mix asphalt rejuvenator is Hydrolene 600T.

In some embodiments, the asphalt product further comprises a surfactant.

Suitable surfactants that can be used include cationic emulsifying agents, anionic emulsifying agents, nonionic emulsifying agents, lecithin, and a combination thereof.

In some embodiments, the asphalt product further comprises a mineral aggregate.

Suitable mineral aggregates are typically composed of sand, gravel, limestone, crushed stone, slag, and mixtures thereof.

Suitable mineral aggregates include sand, gravel, limestone, quartzite, granite, crushed stone, recycled asphalt pavement (RAP), recycled asphalt shingles (RAS), and combinations thereof.

Another aspect of the present disclosure relates to a roofing shingle comprising any asphalt product described herein.

For a roofing-grade asphalt material, roofing granules can be applied to a surface of a coated base material. The roofing granules can be used for ultraviolet radiation protection, coloration, impact resistance, fire resistance, another suitable purpose, or any combination thereof. The roofing granules can include inert base particles that are durable, inert inorganic mineral particles, such as andesite, boehmite, coal slag, diabase, metabasalt, nephaline syenite, quartzite, rhyodacite, rhyolite, river gravel, mullite-containing granules, another suitable inert material, or any combination thereof. See U.S. Patent Publ. No. 2013/0160674 to Hong et al., which is hereby incorporated by reference in its entirety.

Another aspect of the present disclosure relates to a coating composition comprising the core-shell particles described herein.

In some embodiments, the coating is a compostable primer coating.

The coating compositions can be used as single-use packaging films in the food packaging industry. Containers used for packaging food items such as food, beer and beverages must meet strict standards. These requirements generally include excellent curability, excellent coating adhesion, fog resistance, retort resistance, and corrosion resistance.

Another aspect of the present disclosure relates to single-use packaging films comprising the coating composition described herein.

The coating composition of the present disclosure may also include a pigment. Pigments are preferably used to give the coating composition the required finishing treatment on the packaging. Suitable pigments for use can be present in an amount sufficient to give the coated substrate the desired opacity, color, finish texture and/or general aesthetic quality. Suitable pigments include aluminum oxide, titanium oxide, zinc oxide, and the like. The typical amount of pigment that can be used depends on the intended finish and is preferably less than about 30 wt % of the coating composition.

In some embodiments, rheology or flow control agents may be added to the coating compositions. The rheology or flow control agent can provide the coating composition with an improved ability to coat uniformly when applied to a substrate. Suitable rheology or flow control agents include acrylics, silicones, waxes, and the like.

The above disclosure is general. A more specific description is provided below in the following examples. The examples are described solely for the purpose of illustration and are not intended to limit the scope of the present disclosure. Changes in form and substitution of equivalents are contemplated as circumstances suggest or render expedient. Although specific terms have been employed herein, such terms are intended in a descriptive sense and not for purposes of limitation.

### EXAMPLES

The following Examples are presented to illustrate various aspects of the present disclosure, but are by no means intended to limit its scope.

### Example 1—Materials and Methods

DL-1,2 Isopropylideneglycerol (solketal), methyl acrylate, butyl acrylate, allyl methacrylate, butanediol diacrylate, sodium dodecyl sulfate, potassium persulfate, sodium bicarbonate, Tergitol-15-S-40-70%, and the enzyme lipase acrylic resin Candida antarctica lipase (Novozyme 435) were purchased from Sigma-Aldrich. Rhodapex EST-30, Sipomer COPS-1, and Sipomer AES-100 were purchased from Alfa Chemistry. All chemicals were used as received.

### Enzymatic Transesterification of Solketal Acrylate

Enzymatic transesterification was carried out using Solketal pre-monomer with excess methyl acrylate, lipase enzyme, and molecular sieves at 40° C. for 24 hours, following the process by Goyal et al., “Glycerol Ketals as Building Blocks for a New Class of Biobased (Meth)Acrylate Polymers,” ACS Sustainable Chem. Eng. 9:(31):10620-10629 (2021), which is hereby incorporated by reference in its entirety.

### Emulsion Polymerization

### Seed Stage

A process called seeded semi-batch emulsion polymerization was used to create the core-shell particles (CSPs). The process involved mixing 350 parts per hundred monomer (phm; with respect to water), 2 phm of sodium dodecyl sulfate, and 0.65 phm of 5 wt % sodium bicarbonate in a three-neck round-bottom flask equipped with a condenser, a mechanical agitator, and a feed port. The aqueous layer was stirred for five minutes before adding 100 phm of butyl acrylate. The mixture was then vigorously stirred for 30 minutes while slightly purging with argon. When the reaction was emulsified, the temperature was raised to 80° C. At this temperature, 0.65 phm of 2 wt % KPS was injected into the reaction. The reaction was left to continue for 2.5 hours before it was cooled. The 20 wt % solids emulsion was then filtered through a 50-micron sieve and stored.

### Core Growth Stage

A pre-emulsion was created by combining an aqueous layer made from 2.4 parts per hundred of Rhodapex EST-30, 0.5 parts per hundred of Tergitol 15-S-40-70%, 30 parts per hundred of deionized water, 0.2 parts per hundred of KPS-2 wt %, 0.5 parts per hundred of Sipomer COPS-1, and 0.5 parts per hundred of Sipomer AES-100 with an oil layer consisting of 49.4 phm of butyl acrylate, 49.4 phm of solketal acrylate, 0.8 phm of allyl methacrylate, and 0.4 phm of butanediol diacrylate. This was done by adding the oil layer dropwise to the aqueous layer under vigorous stirring in a beaker equipped with a stir bar. In a three-neck round-bottom flask equipped with an agitator, a condenser, and a feed port, 39 parts per hundred (phm) of the previously prepared seed latex, 60 phm of deionized (DI) water, 0.1 phm of KPS 2 wt %, 0.25 phm of sodium bicarbonate 5 wt %, and 0.3 phm of Rhodapex EST-30 were combined. The mixture was continuously purged with slight argon gas and heated to 80° C. Then, the pre-emulsion was slowly added to the pre-made seed latex over 90 minutes. The mixture was further reacted for an additional 45 minutes after the feeding period to create a core growth layer.

### Shell Growth Stage

An emulsion was created by mixing an aqueous layer consisting of 2.7 phm of Rhodapex EST-30, 0.5 phm of Tergitol 15-S-40-70%, 0.5 phm of Sipomer COPS-1, 0.5 phm of Sipomer AES-100, 0.2 phm of KPS-2 wt %, 30 phm of DI water, and 0.25 phm of sodium bicarbonate 5 wt % with an oil layer made up of 98.8 phm of methyl methacrylate, 0.8 phm of allyl methacrylate, and 0.4 phm of butanediol diacrylate. The oil layer was slowly added to the aqueous layer to create the emulsion while stirring the mixture in a beaker with a stir bar. After the emulsion was formed, it was fed into the core stage for 60 minutes and allowed to react for 30 minutes after the shell stage feeding.

### Functional Shell Growth Stage

An emulsion was created by mixing an aqueous layer containing 2.7 phm of Rhodapex EST-30, 0.5 phm of Tergitol 15-S-40-70%, 0.5 phm of Sipomer COPS-1, 0.5 phm of Sipomer AES-100, 0.2 phm of KPS-2 wt %, 30 phm of DI water, and 0.25 phm of sodium bicarbonate 5 wt %. The oil layer containing 98 phm of methyl methacrylate and 2 phm of glycidyl methacrylate was mixed and added dropwise into the aqueous layer while vigorously stirring. Once the emulsion was mixed, it was fed into the shell stage for 60 minutes and allowed to react for an additional 60 minutes. The reaction was then cooled down and filtered through a 50-micron sieve before storage.

### Preparation of Polymer Blends

Depending on the composition, the A+B polymer blends were fabricated by dry mixing a calculated polymer modifier with various amounts of PLA in a small blender. The mixture was then dried at 60° C. for two before melt blending. The polymer was then melt blended using a Process 11 twin screw extruder. The extrudate was cooled and prepared for injection molding. The blends were synthesized at 220° C. with a 45-second residence time at 250 RPM.

### Preparation of Mechanical Property Test Specimens

The extrudate made ASTM D256 Izod bars and ASTM D638 Type 5 dogbones. A Haake MiniJet injection molder was used with the barrel temperature set to 240° C. and a mold temperature of 40° C. The Ram pressure was set to 700 bar. Notches were then created under the ASTM D256 Specifications.

### Mechanical Property Tests

Uniaxial tensile tests were performed with an Instron 3367 Tensile Tester using a cross-head moving rate of 5 mm/min. Impact Tests were conducted using a Tinius Olsen 527. The value reported was represented as an average of over five specimens.

### Analysis of Microstructure

Microstructure analysis was performed on a 200 kV JEOL 2100 Scanning/Transmission Electron Microscope. Each Transmission Electron Microscopy (TEM) specimen was ultra-microtomed at −70° C. in the whitened gauge region of the tensile bar. Scanning Electron Microscopy (SEM) was performed on the Izod fracture surfaces using a FEI Quanta 250 FE-SEM.

### Particle Size Analysis (Dynamic Light Scattering)

Measurements were conducted at 25° C. using a Malvern Instruments Zetasizer Nano series instrument. Polymer dispersions were diluted to 1 wt %. Z-average particle sizes were calculated using the average of three measurements.

Dynamic Scanning calorimetry (DSC)

Modulated DSC was performed using a TA Discovery 2500™. The samples were dried at 100° C. prior to undergoing a 2° C./min ramp from −100° C. to 150° C.

### Example 2—Results and Discussion

All core-shell polymers were synthesized via seeded emulsion polymerization. Using a previously prepared seed latex avoided uncertainty in particle nucleation mechanisms and better batch-to-batch reproducibility. Polymerizations proceeded under monomer-starved conditions leading to a nearly instantaneous monomer conversion rate. A summary of CSPs is shown in Table 1. Molecular characteristics of the core-shell polymers can be viewed by showing particle size, dispersity, amount of crosslinker in the core, and percent glycidyl methacrylate copolymerized into the functional shell. Overall, particle sizes and dispersity did not vary much based on the loading of bioderived monomer, indicating good incorporation into the soft core. Dynamic Light Scattering (DLS) was used to obtain quantitative data about the particle sizes of the emulsions. DLS was used to ensure there was no secondary nucleation during the growth stages of the polymerization. For example, the emulsion polymerization of the batch EP-91 proceeded without any secondary nucleation, indicating an ideal environment for instantaneous polymerization (FIG. 2).

TABLE 1
Summary of the Thermomechanical Properties of the Core-Shell Polymer Blends*

| | | | | | | | | Size | | | |
|---|---|---|---|---|---|---|---|---|---|---|---|
| | | | | | | | % | by | | | |
| | | E | εb | UT | E_{Fract} | % | Cross | TEM | | | |
| Code | σ(MPa) | (GPa) | (%) | (MJ/m³) | (J/m) | GMA | linker | (nm) | Ð | T° C. | RPM |
| PLA | 67 ± 2 | 2.5 ± 0.1 | 3 ± 1 | 1 ± 1 | 76 ± 11 | NA | NA | NA | NA | NA | NA |
| EP-89 | 56 ± 2 | 2.2 ± 0.1 | 58 ± 5 | 18 ± 1 | 140 ± 2 | 2.5 | 5.0 | 193.0 | 0.042 | 210 | 300 |
| EP-90 | 49 ± 2 | 2.0 ± 0.1 | 72 ± 6 | 26 ± 1 | 130 ± 2 | 2.5 | 5.0 | 193.0 | 0.042 | 210 | 300 |
| EP-91 | 58 ± 2 | 2.1 ± 0.1 | 68 ± 6 | 25 ± 1 | 150 ± 2 | 2.5 | 2.5 | 185.0 | 0.025 | 210 | 300 |
| EP-92 | 48 ± 2 | 2.1 ± 0.1 | 119 ± 14 | 35 ± 3 | 175 ± 5 | 2.5 | 2.5 | 185.0 | 0.025 | 210 | 300 |

*Numbers in the sample code dictate the percentage of biobased polymer polymerized into the core

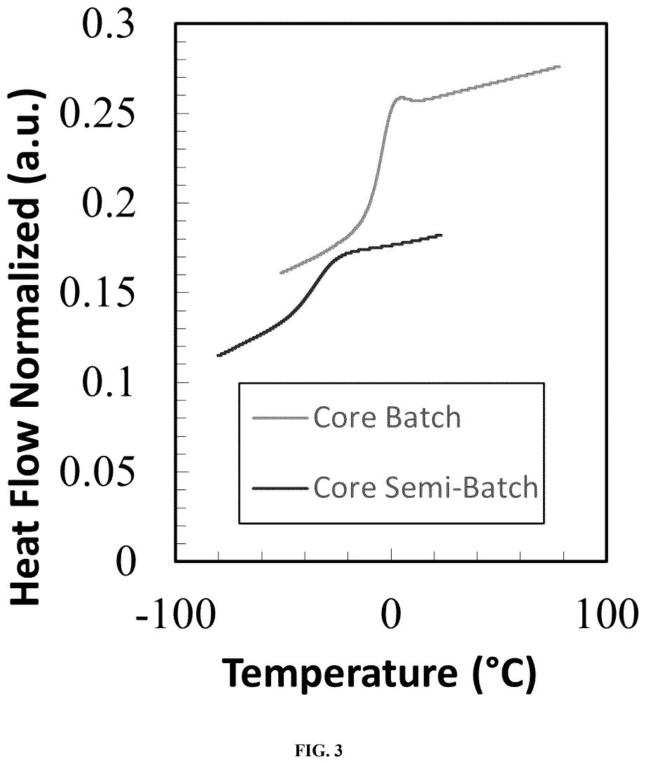

After the formation of the CSP latex, a small sample was precipitated out of the latex, and DSC was performed. FIG. 3 shows the DSC thermograms for solketal acrylate cores akin to EP-90 produced by batch emulsion polymerization and semi-batch emulsion polymerization. The normalized heat flow, plotted against temperature, indicates significant differences in the thermal properties of the two samples. The Core Batch polymer shows a distinctly higher Tg as compared to the semi-batch produced polymer. This difference in Tg is influenced by the degradation of persulfate initiators, which generate local acid sites that can cleave solketal acrylate. In batch polymerization, the cleavage of the solketal ring results in the release of glycerol, a small molecule that disperses into the aqueous phase, minimizing its impact on the core Tg. Conversely, in semi-batch polymerization, the glycerol remains confined within the rigid poly(methyl methacrylate) (PMMA) shell, inducing a self-plasticization effect that lowers the Tg. This encapsulation increases the mobility of the polymer chains, thus modifying the thermal properties of the resulting polymer.

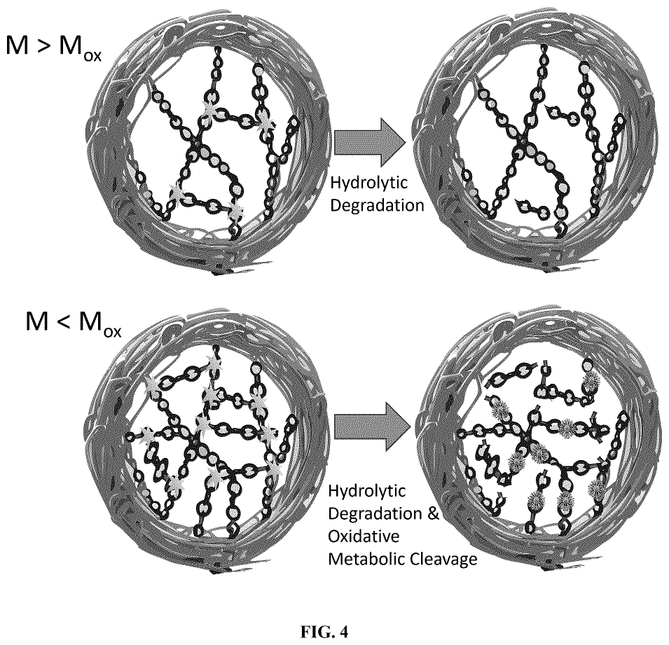

FIG. 4 illustrates the structural differences between polymer cores made from petroleum-based butyl acrylate and biobased solketal acrylate (EP-90). Polymers are challenging to degrade due to their high degree of polymerization. Chain lengths larger than 1200 Da show a significant dropoff in the ability to undergo chain scission (Barbon et al., “Synthesis and Biodegradation Studies of Low-Dispersity Poly(Acrylic Acid),” Macromol. Rapid Commun. 43(13):2100773 (2022), which is hereby incorporated by reference in its entirety). One of the challenges in designing a degradable CSP is to keep the molecular weight between crosslinks low enough to undergo metabolic cleavage while maintaining mechanical performance. The top panel represents the butyl acrylate core, showing the polymerization process transitioning from the initial to final stages. The stars denote ester-based crosslinks, which are susceptible to hydrolytic cleavage. In contrast, the bottom panel shows the solketal acrylate-derived core undergoing a similar polymerization process. The ester-based crosslinks (stars) also appear here, indicating sites vulnerable to hydrolytic cleavage. Additionally, the presence of clusters in the final stage marks sites where biobased solketal acrylate can undergo oxidative metabolic cleavage, leading to significantly higher biodegradability. This structural distinction emphasizes the potential for biobased polymers to introduce unique properties and enhanced environmental benefits, attributed to the chemical nature of solketal acrylate and its interaction within the polymer system.

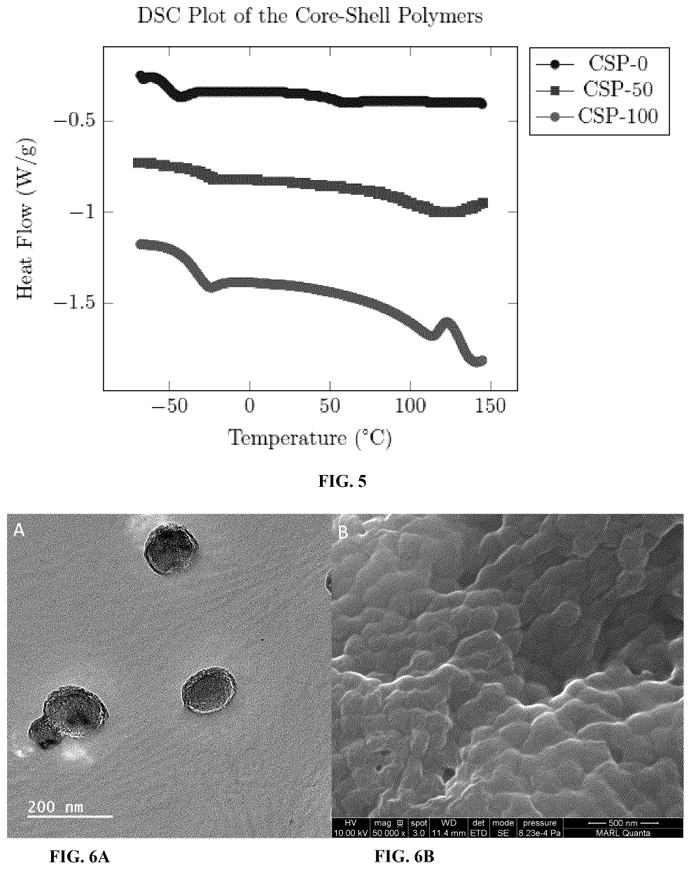

Phase-separated polymers, like block copolymers, will show multiple glass transition temperatures for each polymeric phase. This is due to the energy penalty that must be paid for mixing polymers (Zhang et al., “Engineered Latex Particles Using Core-Shell Emulsion Polymerization: From a Strawberry-like Surface Pattern to a Shape-Memory Film,” ACS Appl. Polym. Mater. 4(2): 1276-1285 (2022), which is hereby incorporated by reference in its entirety). Core-shell polymers follow the same ideology in that a soft core and a rigid shell will display two distinct Tg values, as each layer will not mix homogeneously together but are instead slightly grafted together to ensure microphase separation (Zhu et al., “Emulsion Properties of Poly(n-Butyl Acrylate)/Poly(Methyl Methacrylate) Polymer with Core-Shell Structure,” Asian Journal of Chemistry 25(6):3318-3320 (2013); Li et al., “Grafting Modification of the Reactive Core-Shell Particles to Enhance the Toughening Ability of Polylactide,” Materials (Basel) 10(8):957 (2017); Plessis et al., “Kinetics and Polymer Microstructure of the Seeded Semibatch Emulsion Copolymerization of N-Butyl Acrylate and Styrene,” Macromolecules 34(15):5147-5157 (2001), which are hereby incorporated by reference in their entirety). FIG. 5 distinctly shows multiple glass transition temperatures, corroborating the formation of core-shell polymers. EP-90 and EP-91 both show a rubbery low Tg corresponding to the core and a rigid high Tg corresponding to the shell. Rigid Tgs are fairly broad due to forming 2 polymer shells around the soft polymer core. Interestingly, EP-89 shows 3 distinct Tgs, indicating that the 1st and 2nd shells are completely immiscible with one another. This could be due to a difference in grafting efficiency of the 1st shell to the polymer core when solketal acrylate is present (Guo ct al., “Modification of the Core-Shell Ratio to Prepare PB-g-(MMA-co-St-co-GMA) Particle-Toughened Poly(Butylene Terephthalate) and Poly-carbonate Blends with Balanced Stiffness and Toughness,” RSC Advances 4(102):58880-58887 (2014); Li et al., “New Route to Amphiphilic Core Shell Polymer Nanospheres: Graft Copolymerization of Methyl Methacrylate from Water-Soluble Polymer Chains Containing Amino Groups,” Langmuir 18(22):8641-8646 (2002); Chen et al., “Fabrication of Polyacrylate Core-Shell Nanoparticles via Spray Drying Method,” J. Nanopart. Res. 18(124) (2016); Gang et al., “Effect of Ethyleneglycol Dimethacrylate Crosslinker on the Performance of Core-Double Shell Structure Poly(Vinyl Acetate-Butyl Acrylate) Emulsion,” J. Appl. Polym. Sci. 132:41899 (2015), which are hereby incorporated by reference in their entirety).

TEM and SEM were also performed on the EP-91 core-shell polymer batch to confirm the core-shell structure (FIGS. 6A-6B). The TEM micrograph (FIG. 6A) shows the obvious formation of the core-shell polymer structure. A dark core can be surrounded by a rough lighter lighter-stained shell with an average diameter that agrees closely with the DLS. SEM micrograph (FIG. 6B) also shows the formation of spherical particles aggregated together, with a size that is consistent with the TEM and DLS.

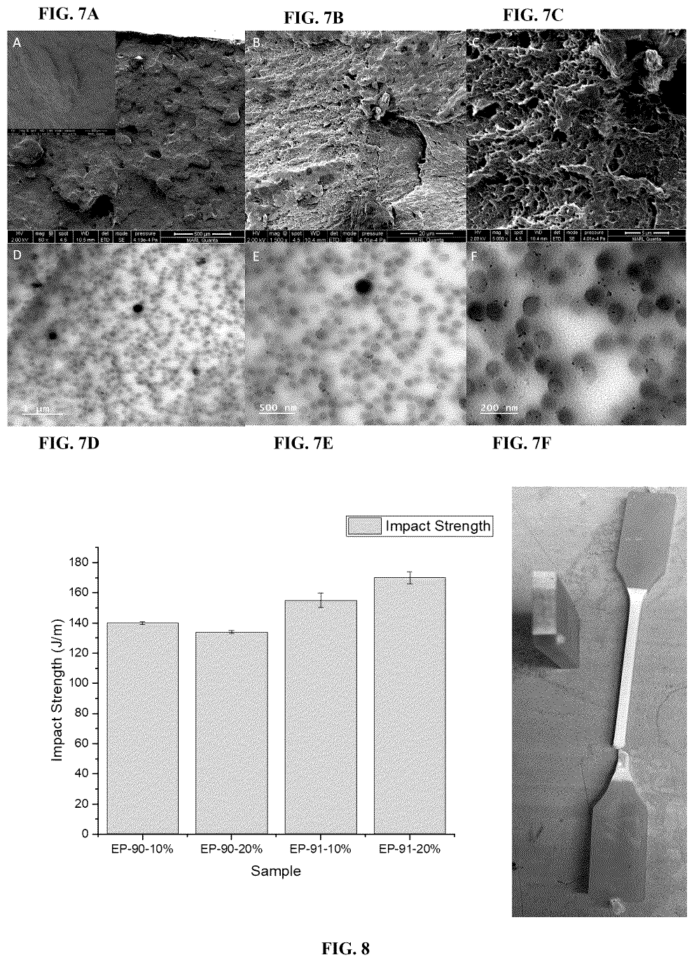

After confirmation of the formation of CSP, the EP-91 core-shell particles were dispersed into PLA via a Process 11 twin-screw extruder. SEM and TEM figures of the PLA/CSP composites can be seen in FIGS. 7A-7F. It is generally believed that the interfacial adhesion and dispersion of the rubber particles are extremely important in toughening thermoplastics. PMMA is generally believed to be miscible with PLA. TEM micrographs indicate proper dispersion of the CSPs into the PLA matrix, as evidenced by the evenly dispersed rubber pockets in the matrix. Stress concentration will be directly correlated to the dispersion of the rubber particles, and SEM micrographs showing the impact surface of the Notched Izod (ASTM D256) specimen can be used to correlate this effect. FIG. 7A shows an extremely rough surface indicating high amounts of plastic deformation; however, the onset image in FIG. 7A shows a pristine PLA surface indicating brittle failure. Further increasing the magnification shows CSP particles initiating shear bands in the PLA matrix, resulting in fibrillation of the PLA matrix, enhancing the toughness of the PLA. An increase in ductility of the PLA matrix results in a large increase in impact strength and stress whitening of the PLA matrix during mechanical deformation, as seen in FIG. 8, which compares the CSP loading and crosslink density between EP-90 and EP-91 as mentioned in Table 1. This further enforces the notion that increasing the crosslink density can affect the rubber embrittlement. Overall, the formation of the CSP results in an order of magnitude increase in both the impact strength of PLA and the elongation.

The results show that biobased core-shell polymers can be synthesized via seeded emulsion polymerization and heavily modify a brittle PLA matrix. Tailoring the interfacial adhesion by altering the shell: core composition resulted in the formation of core-shell polymers. DLS, TEM, and SEM were used to corroborate the formation of core-shell particles and their dispersion in a PLA matrix, which indicated ideal compatibility and adhesion between PLA and the core-shell particles. SEM showed rough fracture surfaces indicating extreme plastic deformation, further identified as fibrillation of the PLA polymer chains. Employing these biobased core-shell polymers opens up avenues for toughened engineering thermoplastics that have the ability to retain their compostability.

### Example 3—Materials and Methods

DL-1,2 Isopropylideneglycerol (solketal), methyl acrylate, butyl acrylate, allyl methacrylate, butanediol diacrylate, sodium dodecyl sulfate, potassium persulfate, sodium bicarbonate, Tergitol-15-S-40-70%, and the enzyme lipase acrylic resin Candida antarctica lipase (Novozyme 435) were purchased from Sigma-Aldrich. Rhodapex EST-30, Sipomer COPS-1, and Sipomer AES-100 were purchased from Alfa Chemistry. Aerosol MA-80 (sodium dihexyl sulfosuccinate) was purchased from Biosynth International, Inc. All other chemicals were used as received.

### Enzymatic Transesterification of Solketal Acrylate

Enzymatic transesterification was carried out using Solketal (pre-monomer) with excess methyl acrylate, lipase enzyme, and molecular sieves at 40° C. for 24 hours, following the process by Goyal et al., “Glycerol Ketals as Building Blocks for a New Class of Biobased (Meth)Acrylate Polymers,” ACS Sustainable Chem. Eng. 9(31):10620-10629 (2021), which is hereby incorporated by reference in its entirety.

### Emulsion Polymerization

### Seed Stage

Seeded semi-batch emulsion polymerization was used to produce CSPs. The seed latex for CSPs was prepared by mixing 350 parts per hundred monomer (phm) water, 2 phm of sodium dodecyl sulfate, and 0.65 phm of 5 wt % sodium bicarbonate in a three-neck round-bottom flask equipped with a condenser, a mechanical agitator, and a feed port. The aqueous layer was stirred for five minutes before adding 100 phm of butyl acrylate. The mixture was then vigorously stirred for 30 minutes while slightly purging with argon. When the reaction was emulsified, the temperature was raised to 80° C. At this temperature, 0.65 phm of 2 wt % KPS was injected into the reaction. The reaction was left to continue for 2.5 hours before it was cooled. The 20 wt % solids emulsion was then filtered through a 50-micron sieve and stored.

### Core Growth Stage

The oil phase, consisting of 49.4 parts per hundred monomer (phm) of butyl acrylate, 49.4 phm of solketal acrylate, 0.8 phm of allyl methacrylate, and 0.4 phm of butanediol diacrylate, was added dropwise to an aqueous phase containing 2.2 phm of Aerosol MA-80, 30 phm of deionized water, 0.2 phm of 2 wt % potassium persulfate (KPS) solution, 0.5 phm of Sipomer COPS-1, and 0.5 phm of Sipomer AES-100. The mixture was stirred vigorously in a beaker equipped with a magnetic stir bar to form a stable pre-emulsion. This pre-emulsion was then used in a seeded semi-batch emulsion polymerization. In a three-neck round-bottom flask equipped with a mechanical agitator, condenser, and feed port, 39 phm of the previously prepared seed latex, 60 phm of deionized water, 0.1 phm of 2 wt % KPS solution, 0.25 phm of 5 wt % sodium bicarbonate solution, and 0.3 phm of Rhodapex EST-30 were combined. The mixture was purged with a gentle stream of argon and heated to 80° C. The pre-emulsion was gradually fed into the seed latex over 90 minutes, followed by an additional 45-minute reaction period to complete the core growth phase.

### Shell Growth Stage

For the shell stage, a pre-emulsion was prepared by combining an aqueous phase containing 2.2 phm of Aerosol MA-80, 0.5 phm of Sipomer COPS-1, 0.5 phm of Sipomer AES-100, 0.2 phm of 2 wt % potassium persulfate (KPS) solution, 0.25 phm of 5 wt % sodium bicarbonate solution, and 30 phm of deionized water with an oil phase composed of 98.8 phm of methyl methacrylate, 0.8 phm of allyl methacrylate, and 0.4 phm of butanediol diacrylate. The oil phase was slowly added to the aqueous phase under vigorous stirring in a beaker equipped with a magnetic stir bar to form a stable emulsion. Once formed, the emulsion was fed into the reactor over 60 minutes following the core growth stage, and the reaction was allowed to proceed for an additional 30 minutes to complete shell formation.

### Functional Shell Growth Stage

Functional shell pre-emulsion was prepared by combining an aqueous phase containing 2.2 phm of Aerosol MA-80, 0.5 phm of Tergitol 15-S-40 (70 wt %), 0.5 phm of Sipomer COPS-1, 0.5 phm of Sipomer AES-100, 0.2 phm of 2 wt % potassium persulfate (KPS) solution, 0.25 phm of 5 wt % sodium bicarbonate solution, and 30 phm of deionized water. An oil phase composed of 98 phm of methyl methacrylate and 2 phm of glycidyl methacrylate was added dropwise into the aqueous phase under vigorous stirring to form a stable emulsion. This emulsion was subsequently fed into the reactor over 60 minutes, followed by an additional 60-minute reaction period to complete the shell formation. The resulting latex was then cooled to room temperature and filtered through a 50-micron sieve prior to storage.

### Preparation of Polymer Blends

Depending on the composition, the A+B polymer blends were fabricated by dry mixing a calculated polymer modifier with various amounts of PLA in a small blender. The mixture was then dried at 60° C. for two hours before melt blending. The polymer was then melt-blended using a Process 11 twin screw extruder. The extrudate was cooled, dried, and prepared for injection molding. The blends were extruded at 220° C. with a 45-second residence time at 500 RPM.

### Preparation of Mechanical Property Test Specimens

The extrudate was molded into ASTM D256 IZOD bars and ASTM D638 Type 5 dogbones. A Haake MiniJet injection molder was used with the barrel temperature set to 220° C. and a mold temperature of 40° C. The Ram pressure was set to 700 bar. Notches were then created under the ASTM D256 Specifications.

### Mechanical Property Tests

Uniaxial tensile tests were performed with an Instron 3367 Tensile Tester using a cross-head speed of 5 mm/min. Impact Tests were conducted using a Tinius Olsen 527. The value reported was represented as an average of over five specimens.

### Analysis of Microstructure

Microstructure analysis was performed on a 200 kV JEOL 2100 Scanning/Transmission Electron Microscope. Sections were prepared via an ultra-microtome at a thickness of 70 nm. Sections of CSP-blended samples were taken as-made, then in both tensile and perpendicular to the pull direction, midway through sample elongation, and after final breakage. Scanning Electron Microscopy (SEM) was performed on the Izod fracture surfaces using a FEI Quanta 250 FE-SEM.

### Particle Size Analysis (Dynamic Light Scattering)

Measurements were conducted at 25° C. using a Malvern Instruments Zetasizer Nano series instrument. Polymer dispersions were diluted to 1 wt %. Z-average particle sizes were calculated using the average of three measurements.

### Dynamic Scanning Calorimetry (DSC)

Modulated DSC was performed using a Discover 2500. The samples were dried at 100° C. prior to undergoing a 2° C./min ramp from −100° C. to 150° C.

### Hydrolysis Testing

Bulk specimens of a solketal acrylate copolymer were immersed in either deionized water (neutral pH) or aqueous hydrochloric acid (2 M HCl) under isothermal conditions. Neutral pH exposures were conducted at 90° C. for up to 5 hours. Acidic exposures were conducted (i) at room temperature for up to 30 hours and (ii) at 40° C. with frequent early sampling during the first 2 hours, followed by additional time points until the response stabilized. All experiments were performed in sealed vessels with sufficient solution volume to fully submerge the specimens and with identical agitation across conditions.

At each prescribed time point, specimens were removed, rinsed with deionized water, air-dried, and analyzed by scanning electron microscopy with energy-dispersive X-ray spectroscopy (SEM-EDS). The surface oxygen-to-carbon (O/C) atomic ratio was measured at multiple fields of view per specimen and averaged across replicates to obtain the time-dependent O/C profiles.

### Example 4—Results and Discussion

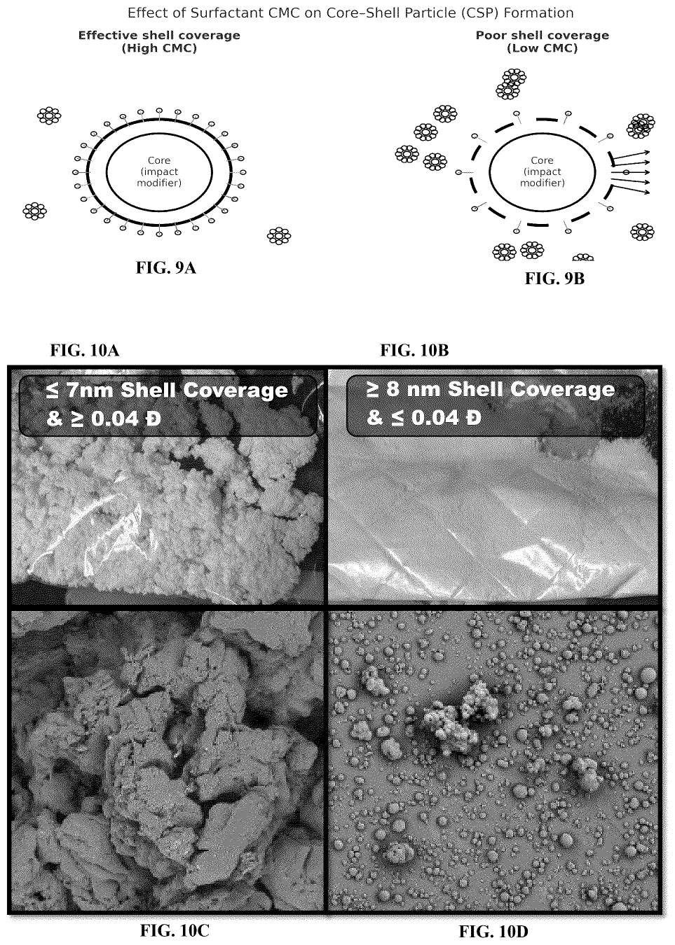

All core-shell polymers were synthesized via seeded emulsion polymerization. Using a previously prepared seed latex avoided uncertainty in particle nucleation mechanisms and better batch-to-batch reproducibility. Polymerizations proceeded under monomer-starved conditions, leading to a nearly instantaneous monomer conversion rate. A summary of CSP composites is shown in Table 2. Molecular characteristics of the core-shell polymers can be viewed by showing particle size, dispersity, amount of crosslinker in the core, and percent glycidyl methacrylate copolymerized into the functional shell. Overall, particle sizes and dispersity did not vary much based on the loading of bioderived monomer, indicating good incorporation into the soft core. DLS was used to obtain quantitative data about the particle sizes of the emulsions. DLS was used to ensure there was no secondary nucleation during the growth stages of the polymerization. When formed from surfactants with a CMC value greater than 0.1 wt % (EP-255), the emulsion polymerization proceeded without any secondary nucleation, indicating an ideal environment for instantaneous polymerization (FIG. 9A). Usage of Surfactants with a CMC value less than 0.1 wt % (EP-188) lead to secondary nucleation leading to poor shell coverage (FIG. 9B). EP-188 which is an analog of EP-91 was synthesized with surfactants having a CMC value less than 0.1 wt % resulted in a mixture of CSPs and PMMA copolymers without cores. Conversely, EP-255 was synthesized using a surfactant with a CMC greater than 0.1 wt %, resulting in the formation of pristine CSP rather than a mixture of products.

TABLE 2
Properties of Polymer Matrix Core-Shell Particle Composites

| | Core | Shell | CSP | | | | Notched | | | |
|---|---|---|---|---|---|---|---|---|---|---|
| Sample | Size | Size | Size | | Shell | | Izod | CMC | | Powder |
| Name | (nm) | (nm) | (nm) | PDI | % | Matrix | (J/m) | (wt %) | pH | Quality |
| EP-188 | 231 | 14 | 244 | 0.053 | 30% | PLA | 134 | 0.09 | 8.1 | Poor |
| EP-191 | 235 | 21 | 256 | 0.063 | 30% | PLA | 130 | 0.09 | 8.2 | Poor |
| EP-192 | 227 | 26 | 253 | 0.069 | 30% | PLA | 125 | 0.09 | 8.3 | Poor |
| EP-193 | 221 | 22 | 242 | 0.049 | 30% | PLA | 115 | 0.09 | 8.1 | Poor |
| EP-200 | 218 | 15 | 233 | 0.059 | 30% | PLA | 117 | 0.09 | 8.4 | Poor |
| EP-248 | 272 | 20 | 307 | 0.066 | 30% | PLA | 84 | 0.09 | 8.5 | Poor |
| EP-251 | 184 | 20 | 204 | 0.029 | 30% | PLA | 150 | 0.10 | 8.6 | Okay |
| EP-254 | 288 | 52 | 321 | 0.024 | 30% | PLA | 165 | 0.10 | 8.2 | Okay |
| EP-255 | 234 | 37 | 271 | 0.027 | 30% | PLA | 360 | 0.10 | 8.2 | Good |
| EP-278 | 262 | 45 | 308 | 0.021 | 30% | PLA | 100 | 0.09 | 8.1 | Poor |
| EP-279 | 264 | 26 | 290 | 0.009 | 30% | PLA | 92 | 0.10 | 8.4 | Poor |
| EP-280 | 269 | 31 | 300 | 0.021 | 30% | PLA | 230 | 0.10 | 8.5 | Good |
| EP-281 | 249 | 34 | 283 | 0.005 | 20% | PLA | 290 | 0.10 | 8.3 | Good |
| EP-282 | 269 | 21 | 290 | 0.028 | 30% | PLA | 130 | 0.09 | 8.1 | Okay |
| EP-283 | 246 | 22 | 268 | 0.002 | 30% | PBT | 52 | 0.10 | 4.1 | Good |
| EP-284 | 266 | 19 | 285 | 0.033 | 30% | PBT | 43 | 0.10 | 4.1 | Good |
| EP-285 | 270 | 4 | 274 | 0.02 | 30% | PBT | 54 | 0.10 | 4.5 | Good |
| EP-289 | 288 | 34 | 322 | 0.002 | 30% | PBT | 48 | 0.10 | 4.2 | Good |
| EP-290 | 264 | 37 | 301 | 0.01 | 30% | PLA | 209 | 0.10 | 8.1 | Good |
| EP-291 | 279 | 41 | 320 | 0.021 | 30% | PBT | 61 | 0.10 | 4.5 | Good |
| EP-292 | 272 | 24 | 296 | 0.019 | 30% | PBT | 61 | 0.10 | 4.5 | Good |
| EP-293 | 269 | 18 | 287 | 0.021 | 30% | PBT | 231 | 0.10 | 8.1 | Good |
| EP-294 | 237 | 28 | 265 | 0.011 | 20% | PBT | 69 | 0.10 | 4.5 | Good |
| EP-295 | 236 | 16 | 252 | 0.007 | 20% | PBT | 98 | 0.10 | 8.1 | Good |
| EP-296 | 269 | 13 | 281 | 0.02 | 20% | PLA | 248 | 0.10 | 8.5 | Good |
| EP-298 | 259 | 37 | 296 | 0.026 | 30% | PBT | 276 | 0.10 | 8.1 | Good |
| EP-299 | 245 | 35 | 280 | 0.015 | 30% | PBT | 249 | 0.10 | 8.1 | Good |
| EP-300 | 263 | 28 | 291 | 0.009 | 30% | PBT | 59 | 0.10 | 5.5 | Good |
| EP-301 | 273 | 9 | 283 | 0.005 | 30% | PLA | 194 | 0.10 | 7.9 | Good |

With the implementation of the CMC changes, the synthesis of EP-255 CSP polymer batch resulted in a small free-flowing powder (FIGS. 10B and 10D). These SEM micrographs show that the spray-dried samples ensured the rubber particles could easily be dispersed into the extruder, while the comparative spray-dried CSP batch of EP-188 shows a large agglomerate clumping together that exhibits poor mixing with the PLA matrix (FIGS. 10A and 10C). This comparison is a qualitative illustration of the effects of complete shell formation promoted by appropriate surfactant selection.

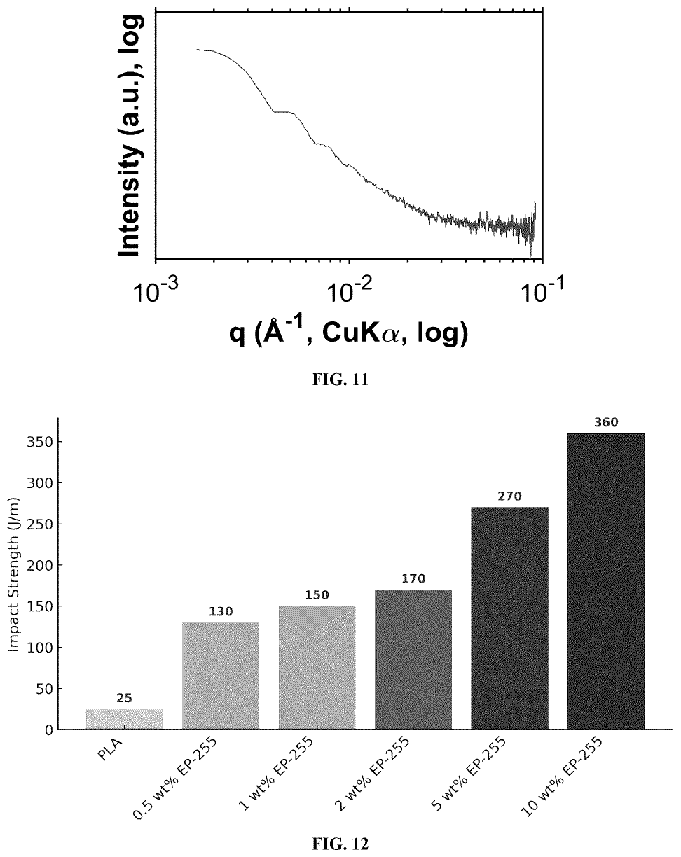

The adjustments made with the CMC and pH led to further improvements in efficiency and performance, which is demonstrated in composites using PLA as the polymer matrix. The Small Angle X-ray Scattering (SAXS) profile (FIG. 11) reveals the characteristic scattering behavior of the core-shell polymer particles dispersed within the PLA matrix. The scattering curve exhibits a monotonic decrease in intensity with increasing scattering vector q, which is typical for spherical or near-spherical particles with a well-defined size distribution. The smooth, featureless decay at low q values (10³ to 10² Å¹) suggests good particle dispersion without significant aggregation or clustering, consistent with the morphological observations from AFM analysis. The absence of sharp peaks or oscillations in the scattering pattern indicates that the core-shell particles do not exhibit long-range ordering or periodic structure within the PLA matrix. The power-law-like decay observed across the measured q-range is characteristic of particles with smooth interfaces and relatively uniform size distribution. The scattering behavior extends across nearly three orders of magnitude in q, providing information about structural features ranging from individual particle dimensions to potential larger-scale morphological heterogeneities. This SAXS data supports the conclusion that the core-shell polymers are well-dispersed as discrete entities within the PLA matrix, which is essential for achieving optimal mechanical property enhancement in the composite material.

The neat PLA control exhibits a baseline impact strength of only 25 J/m (FIG. 12), which is characteristic of the inherently brittle nature of unmodified polylactic acid. The incorporation of EP-255 shows a dramatic and progressive improvement in impact performance with increasing loading levels. At just 0.5% EP-255 loading, the impact strength increases more than fivefold to 130 J/m, demonstrating the exceptional efficiency of this synthesis approach. This enhancement continues systematically with higher loadings, reaching 150 J/m at 1%, 170 J/m at 2%, 270 J/m at 5%, and an outstanding 360 J/m at 10% EP-255 content. The 10% loading represents a remarkable 14.4-fold improvement over the neat PLA baseline, showcasing the superior toughening efficacy of the optimized core-shell polymer architecture. This substantial enhancement in impact resistance indicates that surfactant selection is of critical import to produce core-shell particles with improved particle-matrix adhesion, optimal core-shell morphology, and enhanced energy dissipation mechanisms. Surprisingly, only surfactants with higher CMC values facilitate well-formed core-shell particles with these performance characteristics. This approach is highly promising for developing high-performance biodegradable composites with significantly improved toughness while maintaining the environmental benefits of PLA.

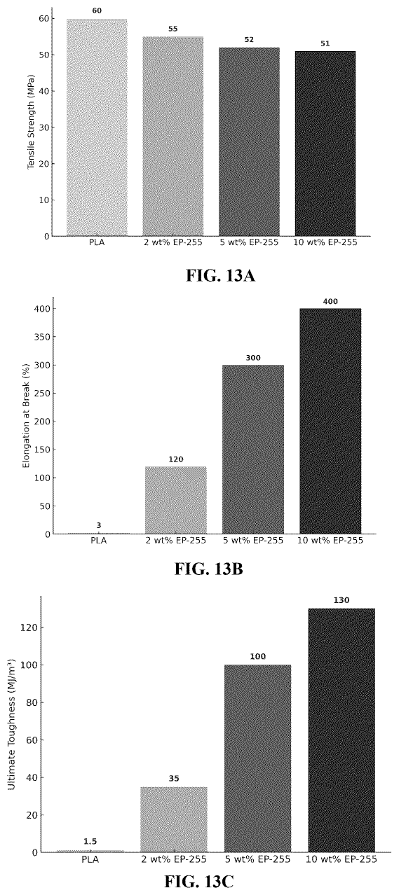

FIG. 13A shows the improved tensile strength, which shows a modest but consistent decrease from 60 MPa for neat PLA to 51 MPa at 10% EP-255 loading, which is typical behavior for rubber-toughened polymer systems where increased flexibility comes at the expense of ultimate tensile strength. However, this relatively small reduction in tensile strength is more than compensated by dramatic improvements in other critical mechanical properties. The elongation at break (FIG. 13B) exhibits spectacular enhancement, increasing from a mere 120% for brittle neat PLA to an impressive 400% at 10% EP-255 loading, representing over a three-fold improvement in ductility. This transformation from brittle to ductile behavior is further supported by the ultimate toughness results (FIG. 13C), which show a remarkable increase from just 35 MJ/m³ for neat PLA to 130 MJ/m³ at 10% EP-255 content, representing nearly a four-fold enhancement in energy absorption capacity. The systematic progression of property improvements with increasing EP-255 loading demonstrates the effectiveness of the core-shell architecture in transforming PLA from a brittle, low-toughness material into a ductile, high-energy-absorbing composite while maintaining acceptable tensile strength levels, making it suitable for demanding applications requiring both biodegradability and mechanical robustness.

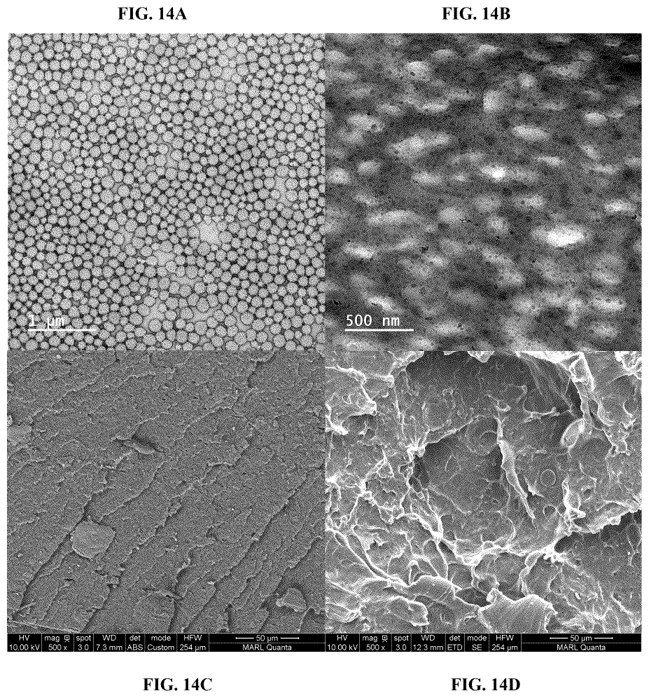

Another prominent polyester matrix partially derived from a biosource is PBT. PBT has similar challenges to PLA; however, PMMA is not miscible with PBT. Generally, it is believed that the interfacial adhesion and dispersion of the rubber particles are extremely important in toughening thermoplastics. Therefore, proper grafting of the CSPs to the PBT matrix must be used to ensure proper dispersion. Polyglycidyl methacrylate can undergo a grafting mechanism, forming ester bonds with the carboxylic chain ends of PBT, further improving the interfacial adhesion and mechanical energy transfer between matrix and dispersed rubber. TEM and SEM were performed on the core-shell polymer to confirm the epoxy functionalized core-shell structure FIG. 14A. A pH between 7.0 and 8.5 preserved the epoxy functionality in EP-293 (analog of EP-255 with epoxies); conversely, EP-283 (analog of EP-255 without epoxies) proceeded in an acidic environment, which ultimately hydrolyzed the epoxy functionality, not giving rise to the ability to form graft copolymers with the PBT polymer matrix. The TEM micrograph shows the obvious formation of the core-shell polymer structure. Additionally, dark patches appear on the shell that can be preferentially stained with a 2 wt % concentration of ruthenium tetroxide. After confirmation of the epoxy functionalities, the EP-293 particles were dispersed into PBT via a Process 11 twin-screw extruder. TEM and SEM figures of the PBT/CSP composites are shown in FIGS. 14B and 14D. These micrographs indicate proper dispersion of the CSPs into the PBT matrix, as evidenced by the evenly dispersed rubber pockets in the matrix. Stress concentration will be directly correlated to the dispersion of the rubber particles, and SEM micrographs showing the IZOD impact surface can be used to correlate this effect. FIG. 14D shows an extremely rough surface, indicating high amounts of plastic deformation. In comparison, the image in FIG. 14C shows a pristine PBT surface indicating brittle failure. Further increasing the magnification shows CSP particles initiating shear bands in the PBT matrix, resulting in fibrillation of the PBT matrix, enhancing the toughness of the PBT. An increase in ductility of the PBT matrix results in a large increase in impact strength and stress whitening of the PBT matrix corresponding to the red arrows during mechanical deformation, FIG. 14B. Overall, the formation of the CSP results in an order of magnitude increase in the impact strength of PBT.

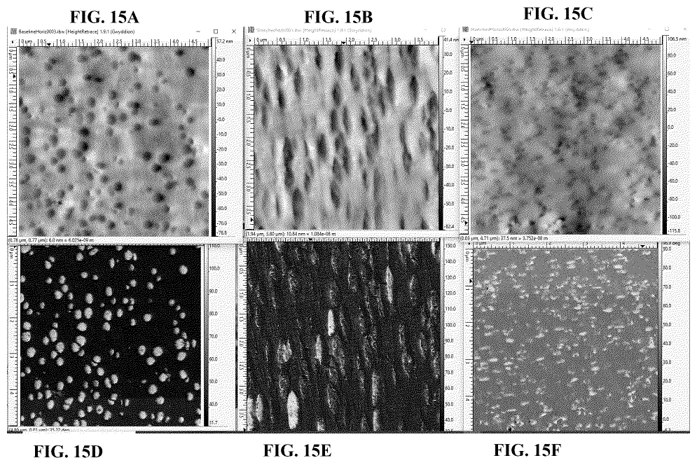

Furthermore FIGS. 15A-15F exhibit a characteristic dispersion of EP-293 in a PBT matrix showing discrete, well-dispersed spherical particles distributed throughout the matrix, indicating good particle-matrix compatibility and uniform dispersion. Upon mechanical deformation, the composite morphology undergoes significant changes (FIGS. 15B, 15C, 15E, and 15F), where the initially spherical CSP particles become elongated and oriented parallel to the direction of applied shear stress. This deformation-induced particle elongation demonstrates the ability of the core-shell architecture to respond to mechanical forces while maintaining structural integrity within the PBT matrix. The elongated particle morphology observed in the deformed samples suggests effective stress transfer from the matrix to the CSP particles, which is crucial for enhancing the mechanical properties of the composite. The preferential orientation of the deformed particles parallel to the shear direction indicates that the core-shell structure can undergo significant shape changes without losing adhesion to the PBT matrix, potentially contributing to improved toughness and energy dissipation mechanisms in the composite material.

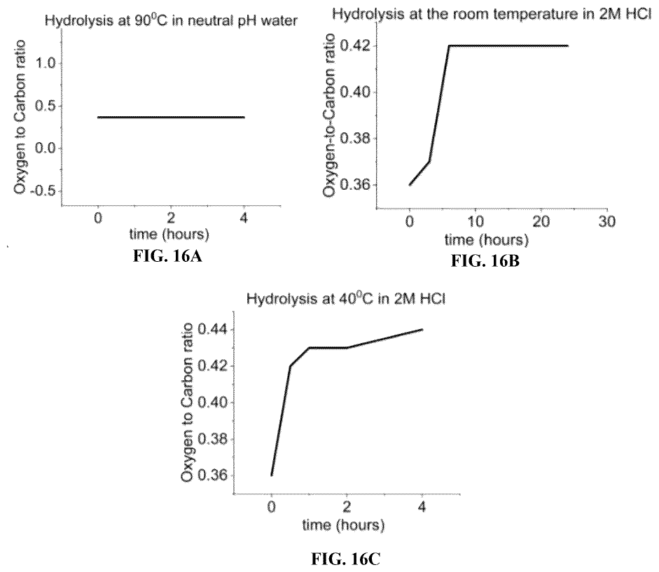

In addition, FIG. 16A shows a hydrolysis test of a solketal acrylate copolymer akin to the core of EP-293 under neutral pH conditions at 90° C. The copolymer exhibits hydrolytic stability with the oxygen-to-carbon ratio remaining essentially constant at approximately 0.3 over a 5-hour period, indicating minimal chain scission or ester bond cleavage. In contrast, acidic conditions dramatically accelerate the hydrolysis process, as evidenced by the significant increase in oxygen-to-carbon ratio observed in both acidic environments. At room temperature in 2M HCl (FIG. 16B), the ratio increases from 0.36 to 0.42 over 30 hours, reaching a plateau that suggests completion of accessible ester bond hydrolysis. The elevated temperature condition at 40° C. in 2M HCl (FIG. 16C) shows an even more rapid degradation kinetics, with the oxygen-to-carbon ratio increasing sharply within the first 2 hours before stabilizing around 0.43-0.44.

The results show that biobased core-shell polymers can be synthesized via seeded emulsion polymerization and heavily modify a brittle PLA and PBT matrix. Tailoring the interfacial adhesion by altering the shell: core composition resulted in the formation of core-shell polymers. DLS, TEM, and SEM were used to corroborate the formation of core-shell particles and their dispersion in a brittle matrix, which indicated ideal compatibility and adhesion between polyester matrices and the core-shell particles. SEM showed rough fracture surfaces indicating extreme plastic deformation, further identified as fibrillation of the brittle matrix polymer chains. Employing these biobased core-shell polymers opens up avenues for toughened engineering thermoplastics that can retain their compostability.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A core-shell particle comprising:
a polymeric core comprising a biodegradable (meth)acrylate polymer; and
a first shell surrounding said core.

2. The core-shell particle of claim 1, further comprising:
a second shell surrounding said first shell.

3. The core-shell particle of claim 1, wherein the core is biobased.

4. The core-shell particle of claim 1, wherein the core-shell particle is biodegradable.

5. The core-shell particle of claim 1, wherein the biodegradable (meth)acrylate polymer comprises glycerol-based monomer.

6. The core-shell particle of claim 1, wherein the biodegradable (meth)acrylate polymer comprises solketal (meth)acrylate, butyl (meth)acrylate, isobornyl (meth)acrylate, octyl (meth)acrylate, lauryl (meth)acrylate, cetyl (meth)acrylate, beheynl (meth)acrylate, glycerol-cyclopentanone ketal (meth)acrylate, acrylated epoxidized methyl (meth)soyate, acrylated epoxidized ethyl hexyl (meth)soyate, glycerol-butanone ketal (meth)acrylate, acrylated epoxidized methyl (meth)soyate, acrylated acetylated epoxidized solketal, tetrahydrofuranyl (meth)acrylate, or tetrahydrofurfuryl glycerol ketal (meth)acrylate.

7. The core-shell particle of claim 1, wherein the core further comprises a crosslinker.

8.-10. (canceled)

11. The core-shell particle of claim 1, wherein the glass transition temperature of the polymeric core is below 0° C.

12. (canceled)

13. (canceled)

14. The core-shell particle of claim 1, wherein the first shell comprises a rigid polymer.

15.-17. (canceled)

18. The core-shell particle of claim 1, wherein the first shell comprises a homopolymer or a copolymer.

19.-24. (canceled)

25. The core-shell particle of claim 1, wherein the particle has a diameter of about 100 nm to about 500 nm.

26. (canceled)

27. A composition comprising:
a plurality of core-shell particles according to claim 1.

28.-32. (canceled)

33. An elastomeric composition comprising the composition of claim 2.

34. (canceled)

35. A toughened engineering thermoplastic composition comprising the composition of claim 27.

36. An adhesive composition comprising:
the composition of claim 27 and
a tackifier and/or a plasticizer blended with the thermoplastic polymeric mixture.

37. A method of making a plurality of core-shell particles comprising:
providing an emulsion that comprises a collection of droplets dispersed in an aqueous medium, wherein the droplets comprise:
a plurality of core polymer particles;
a non-ionic surfactant that is substantially free from alkylphenols and their ethoxylates (APEs); and
a rigid monomer; and
polymerizing the emulsion.

38.-46. (canceled)

47. An article of manufacture comprising:
a plurality of core-shell particles according to claim 1.

48. (canceled)

49. An asphalt product comprising:
an asphalt binder; and
the core-shell particle of claim 1.

50.-55. (canceled)

56. A roofing shingle comprising the asphalt product of claim 49.

57. A coating composition comprising the core-shell particles of claim 1.

58.-66. (canceled)
